(19) United States
(12) Patent Application Publication
(10) Pub. No.: US 2026/0179547 A1
(43) Pub. Date: Jun. 25, 2026

(54) PIXEL DRIVING CIRCUITS, DRIVING METHOD THEREOF AND DISPLAY APPARATUS

(71) Applicants: BEIJING BOE TECHNOLOGY DEVELOPMENT CO., LTD., Beijing (CN); BOE Technology Group Co., Ltd., Beijing (CN)

(72) Inventors: Dingchang Zhang, Beijing (CN); Xuan Feng, Beijing (CN); Minghua Xuan, Beijing (CN); Ming Yang, Beijing (CN); Seungwoo Han, Beijing (CN); Hui Zhang, Beijing (CN); Liwei Liu, Beijing (CN); Zhuo Li, Beijing (CN)

(73) Assignees: BEIJING BOE TECHNOLOGY DEVELOPMENT CO., LTD., Beijing (CN); BOE Technology Group Co., Ltd., Beijing (CN)

(21) Appl. No.: 18/842,195

(22) PCT Filed: Sep. 11, 2023
(86) PCT No.: PCT/CN2023/118007

§ 371 Date: Aug. 28, 2024

(30) Foreign Application Priority Data
Aug. 30, 2023 (WO) PCT/CN2023/115648

(51) Int. Cl. G09G 3/3233; G09G 3/32

(52) U.S. Cl. CPC G09G 3/3233; G09G 3/32; G09G 2300/0413; G09G 2300/0819; G09G 2300/0852; G09G 2300/0861; G09G 2310/0286; G09G 2310/08; G09G 2320/0223; G09G 2320/0233; G09G 2320/0252; G09G 2320/045; G09G 2330/021

(57) ABSTRACT

In the present application, by disposing transistors, capacitors and timing sequence signals, the pixel driving circuits can separate an anode of the light emitting device from a source electrode of a driving transistor, so that before a light emitting stage, the light emitting device itself may not affect the change of the potential of the source electrode of the driving transistor. Meanwhile, by setting the capacitance value, precise adjustment of the driving current can be achieved, and richer gray-scale display is achieved. Furthermore, the pixel driving circuits can utilize gate driving signals provided by gate lines in different rows, so that the quantity of required external signal lines is small, and the type and quantity of shift registers (or driver chips) externally connected to the pixel driving circuits are significantly decreased, which is beneficial for manufacturing a display apparatus with a narrow border frame.

### CROSS-REFERENCES TO RELATED APPLICATIONS

The present application claims the priority of the Chinese patent application filed on Aug. 30, 2023 before the China National Intellectual Property Administration with the application number of PCT/CN2023/115648 and the title of “PIXEL DRIVING CIRCUITS, DRIVING METHOD THEREOF AND DISPLAY APPARATUS”, which is incorporated herein in its entirety by reference.

### TECHNICAL FIELD

The present application relates to the technical field of displaying and, more particularly, to pixel driving circuits, a driving method thereof and a display apparatus.

### BACKGROUND

With the continuous development of the display industry, research on display pixel driving circuits has gradually become an important hotspot.

A light-emitting diode is one of the important display devices, however, the light-emitting diode is a current driving device, the light-emitting brightness and time of the light-emitting diode are influenced by the current magnitude and driving time. In practical applications, negative factors such as coupling capacitances in the pixel driving circuits, a leakage current phenomenon existing in each transistor, a threshold voltage (Vth) offset of transistors due to non-uniform transistor preparation processes in the display panel, a threshold voltage drift caused by long-term unidirectional voltage bias of the light-emitting diode, and a voltage drop issue (IR Drop) caused by wire resistance in the circuit all affect the stability of the pixel driving circuits, resulting in uneven light-emitting brightness of the light-emitting diode and reducing display effects of display products.

### SUMMARY

The following technical solutions are adopted by the embodiments of the present application.

In a first aspect, pixel driving circuits are provided by the embodiments of the present application, wherein the pixel driving circuit in an nth row includes:
a first reset sub-circuit electrically connected to a first reset signal line, a first scanning signal line, a first node, a second reset signal line, a controlling signal line and a second node, and configured to reset a voltage of the first node under control of a first scanning signal and reset the second node under control of a first controlling signal;
a data writing sub-circuit electrically connected to a data line, a third scanning signal line and the second node, and configured to write a data signal transmitted by the data line into the second node;
a driving transistor, a gate electrode of the driving transistor being electrically connected to the second node, a first pole of the driving transistor being electrically connected to a third node, and a second pole of the driving transistor being electrically connected to the first node, and the driving transistor being configured to generate a driving current under control of a voltage of the second node;
a light emitting controlling sub-circuit electrically connected to a light emitting controlling signal line, a first power line, the third node, the first node and an anode of a light emitting device, and configured to, when the driving transistor is turned on, conduct a path between the first power line and a cathode of the light emitting device;
a compensating sub-circuit electrically connected to a fourth scanning signal line, the first power line and the third node, and configured to complete reading of a threshold voltage of the driving transistor in cooperation with the first reset sub-circuit;
a storing sub-circuit electrically connected to the first node, the second node and the first power line, and configured to store the voltage of the second node and adjust the voltage of the first node;
a second reset sub-circuit electrically connected to the anode, a fifth scanning signal line and a second power line, and configured to reset the anode under control of a fifth scanning signal;
wherein n is a positive integer, the first scanning signal line, the third scanning signal line, the fourth scanning signal line and the fifth scanning signal line are gate lines in different rows.

In the at least one embodiment of the present application, the controlling signal line includes the first scanning signal line or a second scanning signal line.

In the at least one embodiment of the present application, a pulse width of a scanning signal loaded on the first scanning signal line, a pulse width of a scanning signal loaded on the third scanning signal line, a pulse width of a scanning signal loaded on the fourth scanning signal line and a pulse width of a scanning signal loaded on the fifth scanning signal line are same.

In the at least one embodiment of the present application, the first scanning signal line is a gate line in an (n−4)th row, the third scanning signal line is a gate line in the nth row, the fourth scanning signal line is a gate line in an (n−2)th row, and the fifth scanning signal line is a gate line in an (n+2)th row; wherein n is greater than 4; and

the instance of pixel driving circuits in an mth row is a dummy pixel driving circuit, m is a positive integer, m is greater than or equal to 1 and less than or equal to 4, equal to n+1 or n+2; the pixel driving circuit in the mth row is electrically connected to a shift register in the mth row.

In the at least one embodiment of the present application, the first reset signal line includes a reference signal line, and the second reset signal line includes an initialization signal line, an absolute value of a difference between a voltage of a reference signal transmitted by the reference signal line and a voltage of an initialization signal transmitted by the initialization signal line is greater than the threshold voltage of the driving transistor.

In the at least one embodiment of the present application, the first reset signal line includes the first power line, and the second reset signal line includes the second power line.

In the at least one embodiment of the present application, the data writing sub-circuit includes a first transistor, a gate electrode of the first transistor is electrically connected to the third scanning signal line, a first pole of the first transistor is electrically connected to the data line, and a second pole of the first transistor is electrically connected to the second node.

In the at least one embodiment of the present application, when the controlling signal line includes the second scanning signal line, the data writing sub-circuit includes a first transistor and a ninth transistor; and

a gate electrode of the first transistor is electrically connected to the third scanning signal line, a first pole of the first transistor is electrically connected to the data line, and a second pole of the first transistor is electrically connected to a first pole of the ninth transistor, a gate electrode of the ninth transistor is electrically connected to the second scanning signal line, and a second pole of the ninth transistor is electrically connected to the second node.

In the at least one embodiment of the present application, a third scanning signal and a second scanning signal overlap in time.

In the at least one embodiment of the present application, when the controlling signal line includes the second scanning signal line, the data writing sub-circuit includes a first transistor, a ninth transistor, and a tenth transistor; and

a gate electrode of the first transistor is connected to the third scanning signal line, a first pole of the first transistor is electrically connected to the data line, a second pole of the first transistor is electrically connected to a first pole of the ninth transistor, a gate electrode of the ninth transistor is electrically connected to the second scanning signal line, a second pole of the ninth transistor is electrically connected to the second node, a first pole of the tenth transistor is electrically connected to the data line, a second pole of the tenth transistor is electrically connected to the first pole of the ninth transistor, and a gate electrode of the tenth transistor is electrically connected to a sixth scanning signal line.

In the at least one embodiment of the present application, a sixth scanning signal and a second scanning signal overlap in time.

In the at least one embodiment of the present application, when the controlling signal line includes the first scanning signal line, the data writing sub-circuit includes a first transistor, a ninth transistor, and a tenth transistor; and

a gate electrode of the first transistor is electrically connected to the third scanning signal line, a first pole of the first transistor is electrically connected to the data line, a second pole of the first transistor is electrically connected to a first pole of the ninth transistor; a gate electrode of the ninth transistor is electrically connected to a sixth scanning signal line, a second pole of the ninth transistor is electrically connected to the second node, a gate electrode of the tenth transistor is electrically connected to the sixth scanning signal line, a first pole of the tenth transistor is electrically connected to the data line, and a second pole of the tenth transistor is electrically connected to the first pole of the ninth transistor.

In the at least one embodiment of the present application, the sixth scanning signal line is a gate line in an (n−1)th row, and a pulse width of a scanning signal loaded on the sixth scanning signal line is the same as a pulse width of a scanning signal loaded on the first scanning signal line.

In the at least one embodiment of the present application, when the controlling signal line includes the second scanning signal line, the first reset sub-circuit includes a second transistor and a fourth transistor; and

a gate electrode of the second transistor is electrically connected to the second scanning signal line, a first pole of the second transistor is electrically connected to the second reset signal line, a second pole of the second transistor is electrically connected to the second node; a gate electrode of the fourth transistor is electrically connected to the first scanning signal line, a first pole of the fourth transistor is electrically connected to the first reset signal line, and a second pole of the fourth transistor is electrically connected to the first node.

In the at least one embodiment of the present application, when the controlling signal line includes the first scanning signal line, the first reset sub-circuit includes a second transistor, a fourth transistor and an eighth transistor; and

a gate electrode of the second transistor and a gate electrode of the fourth transistor are both electrically connected to the first scanning signal line, a first pole of the second transistor is electrically connected to the second reset signal line, a second pole of the second transistor is electrically connected to the second node; a first pole of the fourth transistor is electrically connected to the first reset signal line, and a second pole of the fourth transistor is electrically connected to the first node; a gate electrode of the eighth transistor is electrically connected to the fourth scanning signal line, a first pole of the eighth transistor is electrically connected to the second reset signal line, and a second pole of the eighth transistor is electrically connected to the second node.

In the at least one embodiment of the present application, the light emitting controlling sub-circuit includes a third transistor and a fifth transistor; and

a gate electrode of the third transistor and a gate electrode of the fifth transistor are both electrically connected to the light emitting controlling signal line; a first pole of the third transistor is electrically connected to the first power line, and a second pole of the third transistor is electrically connected to the third node; a first pole of the fifth transistor is electrically connected to the first node, and a second pole of the fifth transistor is electrically connected to the anode.

In the at least one embodiment of the present application, the compensating sub-circuit includes a seventh transistor, a gate electrode of the seventh transistor is electrically connected to the fourth scanning signal line, a first pole of the seventh transistor is electrically connected to the first power line, and a second pole of the seventh transistor is electrically connected to the third node.

In the at least one embodiment of the present application, the storing sub-circuit includes a first capacitor and a second capacitor; and

a first electrode of the first capacitor is electrically connected to the second node, a second electrode of the first capacitor is electrically connected to the first node; a first electrode of the second capacitor is electrically connected to the first power line, and a second electrode of the second capacitor is electrically connected to the second electrode of the first capacitor through the first node.

In the at least one embodiment of the present application, the second reset sub-circuit includes a sixth transistor, a gate electrode of the sixth transistor is electrically connected to the fifth scanning signal line, a first pole of the sixth transistor is electrically connected to the anode, and a second pole of the sixth transistor is electrically connected to the second power signal line.

In the at least one embodiment of the present application, when the data writing sub-circuit includes a ninth transistor, a type of the ninth transistor is opposite to types of the other transistors.

In the at least one embodiment of the present application, the ninth transistor is a P-type transistor.

In the at least one embodiment of the present application, when the driving transistor is an N-type transistor, the voltage of the reference signal is greater than the voltage of the initialization signal, and the absolute value of the difference between the voltage of the reference signal and the voltage of the initialization signal is in a range of 2V to 4V.

In the at least one embodiment of the present application, a capacitance value of the second capacitor is less than a capacitance value of the first capacitor.

In the at least one embodiment of the present application, the driving transistor is a double-gate transistor, and one gate electrode of the driving transistor is electrically connected to the second node, and the other gate electrode of the driving transistor is electrically connected to a signal input end with a constant voltage, wherein the constant voltage is less than the threshold voltage of the driving transistor.

In the at least one embodiment of the present application, the light emitting device includes an organic light-emitting diode, a micro light-emitting diode or a sub-millimeter light-emitting diode.

In the at least one embodiment of the present application, all of the third transistor, the fifth transistor and the seventh transistor are double-gate transistors, two gate electrodes of a same transistor are electrically connected together; or

all of the third transistor, the fifth transistor and the seventh transistor are metal oxide transistors.

In a second aspect, a display apparatus is provided by the embodiments of the present application, wherein the display apparatus includes the pixel driving circuits stated in any one of the embodiments of the first aspect.

In a third aspect, a driving method is provided by the embodiments of the present application, applied to drive the pixel driving circuits stated in any one of the embodiments of the first aspect, the driving method includes:
in a first stage, inputting a low level light emitting controlling signal to the light emitting controlling signal line, inputting a high level first scanning signal to the first scanning signal line, inputting a low level fourth scanning signal to the fourth scanning signal line, inputting a low level third scanning signal to the third scanning signal line, and inputting a low level fifth scanning signal to the fifth scanning signal line;
in a second stage, inputting the low level light emitting controlling signal to the light emitting controlling signal line, inputting a low level first scanning signal to the first scanning signal line, inputting a high level fourth scanning signal to the fourth scanning signal line, inputting the low level third scanning signal to the third scanning signal line, and inputting the low level fifth scanning signal to the fifth scanning signal line;
in a third stage, inputting the low level light emitting controlling signal to the light emitting controlling signal line, inputting the low level first scanning signal to the first scanning signal line, inputting the low level fourth scanning signal to the fourth scanning signal line, inputting a high level third scanning signal to the third scanning signal line, and inputting the low level fifth scanning signal to the fifth scanning signal line;
in a fourth stage, inputting the low level light emitting controlling signal to the light emitting controlling signal line, inputting the low level first scanning signal to the first scanning signal line, inputting the low level fourth scanning signal to the fourth scanning signal line, inputting the low level third scanning signal to the third scanning signal line, and inputting a high level fifth scanning signal to the fifth scanning signal line; and
in a fifth stage, inputting a high level light emitting controlling signal to the light emitting controlling signal line, inputting the low level first scanning signal to the first scanning signal line, inputting the low level fourth scanning signal to the fourth scanning signal line, inputting the low level third scanning signal to the third scanning signal line, and inputting the low level fifth scanning signal to the fifth scanning signal line.

The above description is merely a summary of the technical solutions of the present application. In order to more clearly know the elements of the present application to enable the implementation according to the contents of the description, and in order to make the above and other purposes, features and advantages of the present application more apparent and understandable, the particular embodiments of the present application are provided below.

### BRIEF DESCRIPTION OF THE DRAWINGS

In order to more clearly illustrate the technical solutions of the embodiments of the present application or the related art, the figures that are required to describe the embodiments or the prior art may be briefly described below. Obviously, the figures that are described below are some embodiments of the present application, and a person skilled in the art can obtain other figures according to these figures without paying creative work.

FIG. 1, FIG. 4, FIG. 5, FIG. 7 and FIG. 9 are schematic structural diagrams of five pixel driving circuits according to embodiments of the present application;

FIG. 2 is a timing sequence diagram corresponding to the pixel driving circuit shown in FIG. 1;

FIG. 3 is a timing sequence diagram corresponding to the pixel driving circuit shown in FIG. 4;

FIG. 6 is a timing sequence diagram corresponding to the pixel driving circuit shown in FIG. 5;

FIG. 8 is a timing sequence diagram corresponding to the pixel driving circuit shown in FIG. 7;

FIG. 10 is a timing sequence diagram corresponding to the pixel driving circuit shown in FIG. 9;

FIG. 11 to FIG. 15 are diagrams explaining the device states in different stages when the pixel driving circuit shown in FIG. 1 is under the timing sequence diagram shown in FIG. 2 according to embodiments of the present application;

FIG. 16 to FIG. 20 are diagrams explaining the device states in different stages when the pixel driving circuit shown in FIG. 7 is under the timing sequence diagram shown in FIG. 8 according to embodiments of the present application;

FIG. 21 to FIG. 24 are four schematic diagrams of electrical connections of pixel driving circuits in different rows;

FIG. 25 is a schematic diagram of circuit connection of a display apparatus according to an embodiment of the present application; and

FIG. 26 is another schematic diagram of circuit connection of a display apparatus according to an embodiment of the present application.

### DETAILED DESCRIPTION

The technical solutions in the embodiments of the present application may be clearly and completely described below with reference to the drawings of the embodiments of the present application. Apparently, the described embodiments are merely certain embodiments of the present application, rather than all of the embodiments. All of the other embodiments that a person skilled in the art obtains on the basis of the embodiments of the present application without paying creative work fall within the protection scope of the present application.

In the embodiments of the present application, terms such as “first”, “second”, “third” and “fourth” are used to distinguish identical items or similar items that have substantially the same functions and effects, merely in order to clearly describe the technical solutions of the embodiments of the present application, and should not be construed as indicating or implying the degrees of importance or implicitly indicating the quantity of the specified technical features.

In the embodiments of the present application, an orientation or positional relationship indicated by the terms “upper” and “lower” are based on orientation or positional relationships shown in the drawings, and are merely for convenience of describing the present application and simplifying the description, rather than indicate or imply that the device or element referred to must have a specific orientation, be configured and operated in a specific orientation, and thus cannot be understood as a limitation on the present application.

In the description of the specification, the terms “one embodiment”, “some embodiments”, “exemplary embodiments”, “example”, “specific example” or “some examples” are intended to indicate that specific features, structures, materials or characteristics related to the embodiment or example are included in at least one embodiment or example of the present application. The illustrative indication of the above terms does not necessarily refer to the same one embodiment or example. Moreover, the specific features, structures, materials or characteristics may be included in any one or more embodiments or examples in any suitable manner.

In the embodiments of the present application, the meaning of “a plurality of” is two or more, and the meaning of “at least one” is one or more, unless otherwise specifically defined.

In the embodiments of the present application, the terms “parallel”, “vertical”, “same”, and the like include strict interpretations of “parallel”, “vertical”, “same”, as well as situations where they are “approximately parallel”, “approximately vertical”, “approximately the same”, with certain tolerances considered, taking into account measurements and tolerances related to measurements of specific quantities (for example, limitations of measurement systems), representing acceptable deviation ranges determined by a person skilled in the art for specific values. For example, “approximately” can indicate that the value is within one or more standard deviations, or the value is within 10% or 5% of the value.

Unless otherwise specified in the context, the term “including” is interpreted as meaning open-ended or inclusive throughout the entire specification and claims, i.e., “including, but not limited to”.

In the embodiments of the present application, “same layer” refers to the relationship between multiple film layers formed of the same material after undergoing the same step (for example, a single-step patterning process). Here, “same layer” does not always mean that the thicknesses of multiple film layers are the same or that the heights of multiple film layers are the same in a cross-sectional view. The polygons mentioned in the specification are not strictly defined and can be approximate triangles, parallelograms, trapezoids, pentagons, or hexagons, etc., with some minor deformations due to tolerances.

In an embodiment of the present application, since a source electrode and a drain electrode of a transistor are symmetrical, the source electrode and the drain electrode of the transistor can be interchanged. In an embodiment of the present application, one of the source electrode and the drain electrode of the transistor is called the first pole, and the other is called the second pole.

In an embodiment of the present application, the term of “electrical connection” may refer to the direct electrical connection of two components, or the electrical connection between two components through one or more other components.

The present application is improved based on the traditional 5TIC (5 transistors and 1 capacitor) source electrode following internal compensation pixel driving circuit. In the source electrode following compensation pixel circuit, a threshold voltage (Vth) of the driving transistor is written into the source electrode of the driving transistor by the method of compensation, so the stability of the source electrode potential of the driving transistor is very important. Although the traditional 5T1C pixel driving circuit can achieve compensating the threshold voltage (Vth) of the driving transistor, there are still some problems such as: 1. during the driving process, the source electrode of the driving transistor is always directly connected to an anode of the light-emitting diode, thus the source electrode of the driving transistor may be affected by the instability of the anode potential caused by the uneven manufacturing procedure of the diode and the threshold voltage drift caused by that the diode undergoes the unidirectional voltage bias for a long time; 2. because the light-emitting diode itself has a capacitance, a size of the capacitance is equivalent to a parasitic capacitance of the transistor, it is very easy to form a capacitive coupling circuit, so that some scanning signals in the pixel circuits interferes the potentials of the key nodes (such as the gate electrode and source electrode of the driving transistor) in the circuit when the potential changes; 3. after the compensation stage, the transistor and the light-emitting diode in the circuit may inevitably leak currents, which may have a negative impact on the compensation effect of the threshold voltage of the driving transistor; 4. the brightness change of the light-emitting diode is greatly affected by the change of the operating current, that is, a smaller change of the operating current may cause a larger change of the display brightness. When the pixel driving circuit in the related art is used for the display apparatus of Micro LED (Micro light-emitting diode) or Mini LED (Mini light-emitting diode (sub-millimeter light-emitting diode)), the pixel driving circuit cannot adjust the fineness of the change of the operating current of the light-emitting diode, so that the adjustment accuracy of the display gray scale of the pixel driving circuit is low.

Based on this, pixel driving circuits, a driving method thereof and a display apparatus are provided by the embodiments of the present application. The above problems can be improved by the pixel driving circuits by disposing transistors, capacitors and timing sequence signals. In addition, the gate electrode driving signals provided by the gate lines in different rows can be utilized by the pixel driving circuits to reduce the quantity of required external signal lines, significantly decrease the types and quantities of shift registers externally connected to the pixel driving circuits, which is beneficial for manufacturing a display apparatus with a narrow border frame.

The pixel driving circuits, the driving method thereof and the display apparatus provided by the embodiment of the present application are introduced and explained in combination with the drawings below.

The display apparatus includes a displaying region and a peripheral region located around the displaying region. The displaying region includes a plurality of sub-pixels, each sub-pixel is provided with a light emitting device and a pixel driving circuit that provides the driving signal for the light emitting device.

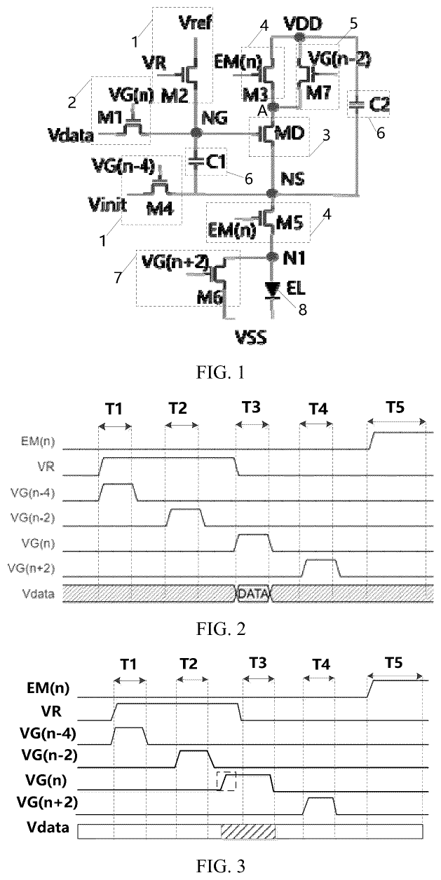

Pixel driving circuits are provided by the embodiments of the present application, as shown in FIG. 1, FIG. 4, FIG. 5, FIG. 7 and FIG. 9, the pixel driving circuit in an nth row includes:
a first reset sub-circuit 1 electrically connected to a first reset signal line (for example, a Ref line), a first scanning signal line (for example, a gate line in an (n−4)th row), a first node NS, a second reset signal line (for example, Vinit line), a controlling signal line (for example, a second scanning signal line VR or the first scanning signal line) and a second node NG, and configured to reset a voltage of the first node NS under control of the VG(n−4) and reset the second node NG under control of a first controlling signal;
a data writing sub-circuit 2 electrically connected to a data line Data line, a third scanning signal line (for example, a gate line in an nth row) and the second node NG, and configured to write a data signal Vdata transmitted by the data line Data line into the second node NG;
a driving transistor MD, a gate electrode of the driving transistor MD is electrically connected to the second node NG, a first pole of the driving transistor MD is electrically connected to a third node A, and a second pole of the driving transistor MD is electrically connected to the first node NS, and the driving transistor MD is configured to generate a driving current under control of a voltage of the second node NG;
a light emitting controlling sub-circuit 4 electrically connected to a light emitting controlling signal line EM(n) line, a first power line VDD line, the third node A, the first node NS and an anode (a position marked by N1) of a light emitting device 8, and configured to, when the driving transistor MD is turned on, conduct a path between the first power line VDD line and a cathode of the light emitting device 8;
a compensating sub-circuit 5 electrically connected to a fourth scanning signal line (for example, a gate line in an (n−2)th row), the first power line VDD line and the third node A, and configured to complete reading of a threshold voltage of the driving transistor MD in cooperation with the first reset sub-circuit 1;
a storing sub-circuit 6 electrically connected to the first node NS, the second node NG and the first power line VDD line, and configured to store the voltage of the second node NG and adjust the voltage of the first node NS;
a second reset sub-circuit 7 electrically connected to the anode N1, a fifth scanning signal line (for example, a gate line in an (n+2)th row) and a second power line VSS line, and configured to reset the anode N1 under control of a fifth scanning signal;
wherein n is a positive integer, the first scanning signal line, the third scanning signal line, the fourth scanning signal line and the fifth scanning signal line are gate lines in different rows.

Here, the specific circuit structures included in the first reset sub-circuit 1, the data writing sub-circuit 2, the light emitting controlling sub-circuit 4, the compensating sub-circuit 5, the storing sub-circuit 6 and the second reset sub-circuit 7 mentioned above are not limited, as long as that the corresponding functions are within the protecting range of the pixel driving circuits according to the embodiments of the present application is met.

The first node NS, the second node NG and the third node A mentioned above are not the actual circuit structure, but only are the concepts defined to facilitate the description of the circuit structure, and this is for clarification purposes.

It should be noted that the above “nth gate line” refers to the gate line corresponding to the sub-pixels in the nth row, that is, the gate line in the nth row, and a gate line is connected to a row of sub-pixels. The meanings of other similar descriptions are similar to that here, and will not be repeated later.

In an exemplary embodiment, the above light emitting device 8 can be light-emitting diode (LED), organic light-emitting diode (OLED), Micro LED (Micro light-emitting diode) or Mini LED (Mini light-emitting diode).

When the light emitting device 8 is an organic light-emitting diode (OLED), the display apparatus can be a silicon-based display apparatus or a glass-based display apparatus. The silicon-based display apparatus refers to that the driving circuit of the display apparatus is disposed on the silicon substrate, and the driving circuit is fabricated by using an MOS (metal oxide semiconductor) process. The glass-based display apparatus refers to that the driving circuit of the display apparatus is disposed on the glass substrate, the driving circuit is fabricated by using a thin film transistor (TFT) process.

In an exemplary embodiment, the first reset sub-circuit 1 can be used to reset the voltages of key nodes (such as the first node NS electrically connected to the driving transistor MD and the second node NG electrically connected to the gate electrode of the driving transistor MD) in the pixel driving circuits before refreshing (re-writing new signals) the pixel driving circuits in the sub-pixels of a row to eliminate residual signals from the previous frame, prevent ghosts from appearing in the next display frame. When the pixel driving circuits are applied in a display apparatus, the display effect of the display apparatus can be improved.

In some embodiments, as shown in FIG. 1 or FIG. 7, the data writing sub-circuit 2 is electrically connected to the data line Data line, the third scanning signal line (for example, the gate line in the nth row), and the second node NG, respectively.

In some other embodiments, as shown in FIG. 4, the data writing sub-circuit 2 is electrically connected to the data line Data line, the third scanning signal line (for example, the gate line in the nth row) and the second node NG, respectively, and the data writing sub-circuit 2 is also electrically connected to the second scanning signal line (for example, the VR line).

In some other embodiments, as shown in FIG. 5, the data writing sub-circuit 2 is electrically connected to the data line Data line, the third scanning signal line (for example, the gate line in the nth row) and the second node NG, respectively. The data writing sub-circuit 2 is also electrically connected to the second scanning signal line (for example, the VR line) and the sixth scanning signal line (for example, the gate line in the (n−1)th row).

In some other embodiments, as shown in FIG. 9, the data writing sub-circuit 2 is electrically connected to the data line Data line, the third scanning signal line (for example, the gate line in the nth row) and the second node NG, respectively, and the data writing sub-circuit 2 is also electrically connected to the sixth scanning signal line (for example, the gate line in the (n−1)th row).

Here, the type of the above driving transistor MD is not limited, and the transistors can be divided into the N-type transistors and the P-type transistor.

Exemplarily, the driving transistor MD stated above can be the N-type transistor or the P-type transistor.

In addition, the first reset sub-circuit 1, the data writing sub-circuit 2, the light emitting controlling sub-circuit 4, the compensating sub-circuit 5 and the second reset sub-circuit 7 stated above also include at least one transistor, respectively.

Here, the types of transistors in the first reset sub-circuit 1, the data writing sub-circuit 2, the first light controlling sub-circuit 4, the compensating sub-circuit 5 and the second reset sub-circuit 7 stated above are not limited.

The transistors in the present application can be independently selected from the N-type transistor or the P-type transistor. Wherein, for the N-type transistor, the operating level state is a high level state, and the non-operating level state is a low level state; for the P-type transistor, the operating level state is the low level state, and the non-operating level state is the high level state. The operating level state refers to the level state that can allow the first pole of the transistor and the second pole of the transistor to be turned on, and the non-operating level state refers to the level state that can allow the first pole of the transistor and the second pole of the transistor to be turned off.

In some examples, the driving transistor MD can include a gate electrode, that is, the gate electrode is electrically connected to the second node NG.

In some other examples, the driving transistor MD can include two gate electrodes, after the two gate electrodes are electrically connected together, they are electrically connected to the second node NG.

In some other examples, the driving transistor MD can include two gate electrodes, the two gate electrodes are connected to different nodes with different potentials. For example, a gate electrode of the driving transistor MD is electrically connected to the second node NG to control the on-state and off-state of the driving transistor MD; the other gate electrode of the driving transistor is electrically connected to a signal input end with a constant voltage to stabilize the threshold voltage of the driving transistor MD and improve the driving stability of the driving transistor MD. Wherein the voltage provided by the signal input end with the constant voltage cannot interfere the on-state and off-state of the driving transistor MD, so that an absolute value of the constant voltage is set to be less than an absolute value of the threshold voltage of the driving transistor MD.

In the exemplary embodiment, the first power line VDD line stated above is a positive power supply signal line, and the second power line VSS line is a negative power supply signal line. Both the first power line VDD line and the second power line VSS line can continuously provide signals with constant voltages. The voltage of the first power signal VDD provided by the first power line VDD line is greater than the second power signal VSS provided by the second power line VSS line.

In some embodiments, the second power signal line VSS can be electrically connected to the ground wire GND.

In the exemplary embodiment, the light emitting controlling sub-circuit 4 is configured to electrically connect the first power line VDD line to the first pole of the driving transistor MD, and is also configured to electrically connect the second pole of the driving transistor MD to the anode of the light emitting device 8, and is also configured to electrically connect the cathode of the light emitting device 8 to the second power line VSS line. When the light emitting controlling sub-circuit 4 and the driving transistor MD are turned on at the same time, pathways are formed on the paths among the positive power signal line, the driving transistor MD, the light emitting device 8 and the negative power signal line, which can make the light emitting device 8 emit light.

In the exemplary embodiment, the light emitting controlling signal EM(n) signal transmitted in the light emitting controlling signal line EM(n) line can be provided by EOA (also known as EM GOA), or can be provided by the driver chip. Wherein EOA refers to the emission control shift register (Emission Control Shift Register On Array), which is configured to provide the light emitting controlling signal to the pixel driving circuits of the sub-pixels in the displaying region AA to control the sub-pixels in the displaying region AA to emit light.

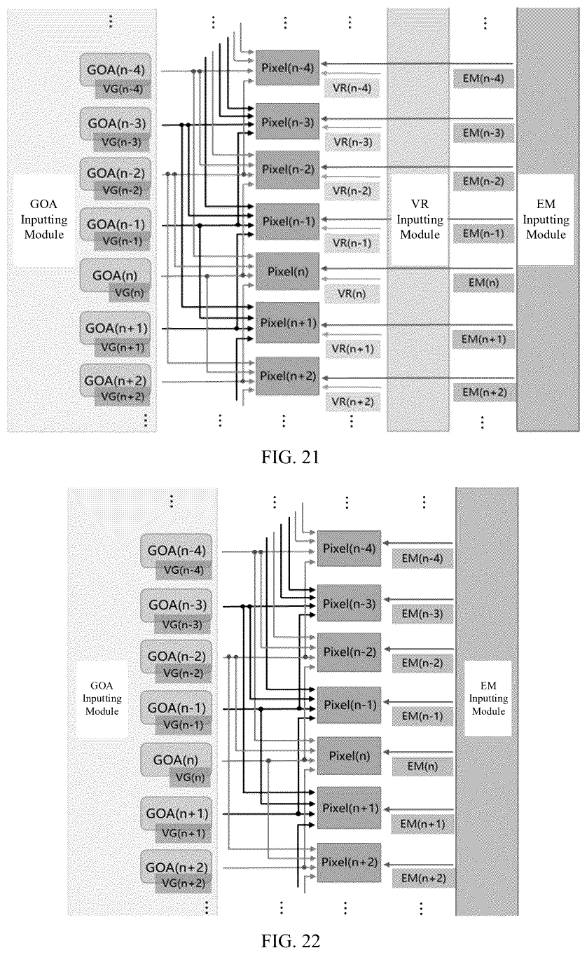

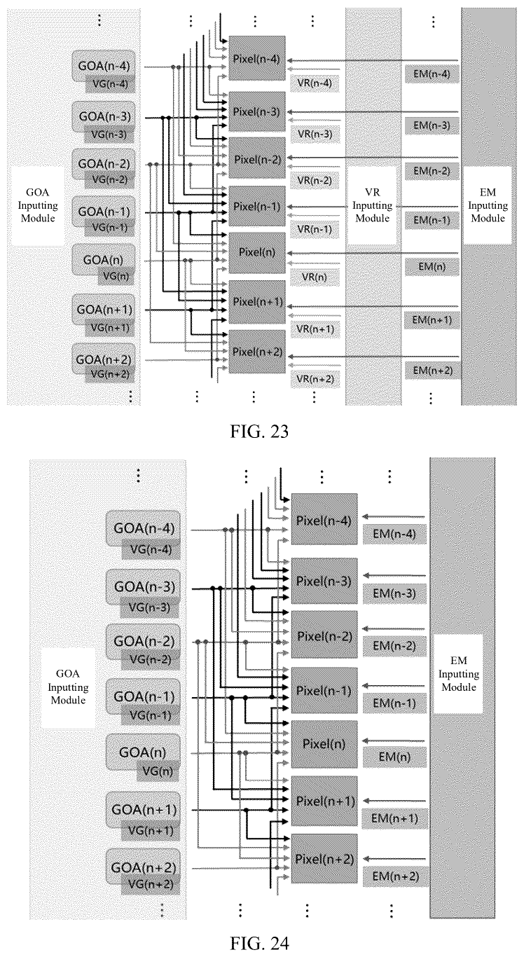

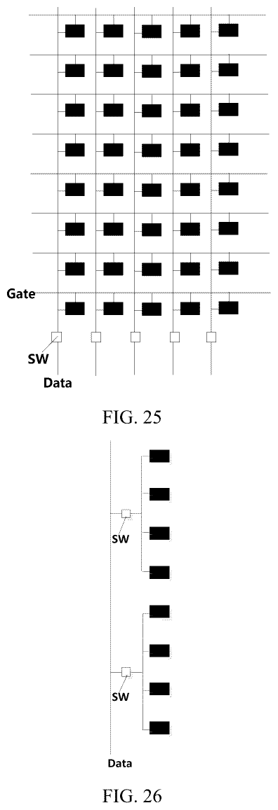

In the exemplary embodiment, as shown in FIG. 21, FIG. 22, FIG. 23 or FIG. 24, sub-pixels of each row correspond to one light emitting controlling signal line EM line, that is, sub-pixels of the same row are electrically connected to the same light emitting controlling signal line EM line.

In the exemplary embodiment, as shown in FIG. 21, FIG. 22, FIG. 23, or FIG. 24, the first scanning signal line, the third scanning signal line, the fourth scanning signal line, and the fifth scanning signal line are gate lines in different rows, that is, for the pixel driving circuit in the nth row, it is not only electrically connected to the gate line in the nth row, but also electrically connected to other gate lines except the gate line in the nth row, so that the gate lines in different rows can provide scanning signals with different timing sequences for the pixel driving circuit, disposing other kinds of signal lines in the area other than the displaying region (the pixel driving circuit is disposed in the displaying region) is avoided to provide driving signals to the pixel driving circuit, thus the quantity of the required external signal lines is reduced. The type and quantity of the shift registers externally connected to the pixel driving circuits are significantly decreased (or when the external signals are provided by using the driver chips ICs, the quantity of ICs externally connected to the pixel driving circuits can be significantly decreased), the power consumption of the display apparatus is reduced to a great extent, and manufacturing a display apparatus with a narrow border frame is facilitated.

In the at least one embodiment of the present application, the controlling signal line includes the first scanning signal line or the second scanning signal line.

In the exemplary embodiment, as shown in FIG. 1, FIG. 4 and FIG. 5, the controlling signal line includes the second scanning signal line VR line.

Wherein the second scanning signal VR signal can be generated by using the driver chip and transmitted to the pixel driving circuits of each row, and can also be generated by using the shift register (EOA) and transmitted to the pixel driving circuits of each row.

In the exemplary embodiment, as shown in FIG. 7 and FIG. 9, the controlling signal line includes the first scanning signal line (for example, the gate line in the (n−4)th row).

In the at least one embodiment of the present application, a pulse width of a scanning signal loaded on the first scanning signal line, a pulse width of a scanning signal loaded on the third scanning signal line, a pulse width of a scanning signal loaded on the fourth scanning signal line and a pulse width of a scanning signal loaded on the fifth scanning signal line are same.

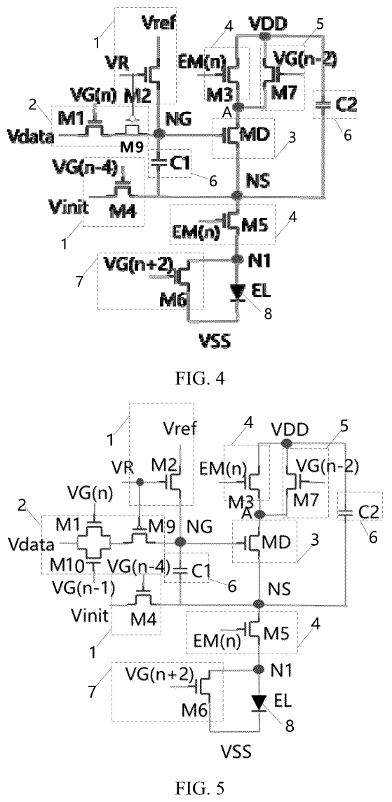

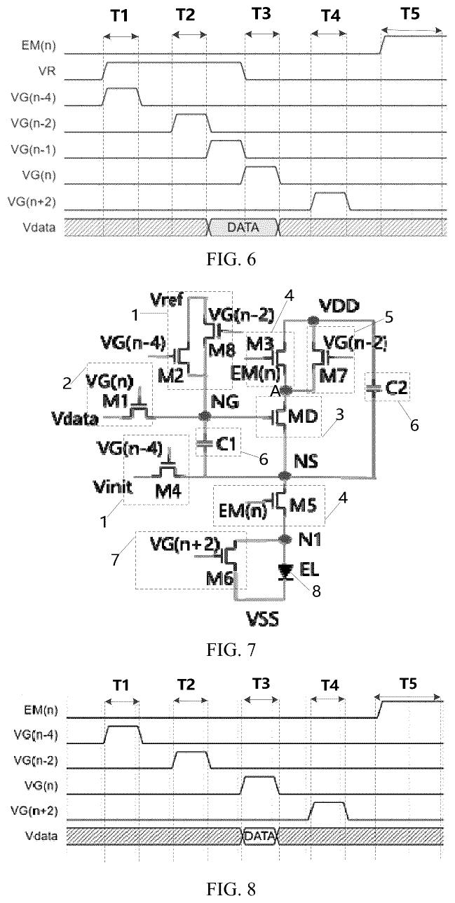

It should be noted that the pulse width of the first scanning signal VG(n−4), the pulse width of the third scanning signal VG(n), the pulse width of the fourth scanning signal VG(n−2) and the pulse width of the fifth scanning signal VG(n+2) drawn in FIG. 2, FIG. 3, FIG. 6 and FIG. 8 are only schematic descriptions, and do not represent the actual pulse widths. In practical applications, the pulse width of the scanning signal on the first scanning signal VG(n−4), the pulse width of the scanning signal on the third scanning signal VG(n), the pulse width of the scanning signal on the fourth scanning signal VG(n−2) and the pulse width of the scanning signal on the fifth scanning signal VG(n+2) are the same.

As shown in FIG. 21, FIG. 22, FIG. 23 or FIG. 24, the first scanning signal VG(n−4), the third scanning signal VG(n), the fourth scanning signal VG(n−2) and the fifth scanning signal VG(n+2) are all generated by the shift registers (GOA).

In the at least one embodiment of the present application, as shown in FIG. 21, FIG. 22, FIG. 23 or FIG. 24, the first scanning signal line is the gate line in the (n−4) row, and the gate line in the (n−4)th row is electrically connected to the shift register GOA (n−4) in the (n−4)th level for transmitting the VG(n−4) signal. The third scanning signal line is the gate line in the nth row, and the gate line in the nth row is electrically connected to the shift register GOA (n) in the nth level for transmitting the VG(n) signal. The fourth scanning signal line is the gate line in the (n−2)th row, and the gate line in the (n−2)th row is electrically connected to the shift register GOA (n−2) in the (n−2)th level for transmitting the VG(n−2) signal. The fifth scanning signal line is the gate line in the (n+2)th row, and the gate line in the (n+2)th row is electrically connected to the shift register GOA (n+2) in the (n+2)th level for transmitting the VG(n+2) signal. Wherein, n is greater than 4.

The gate line in the nth row is electrically connected to the pixel driving circuit in the nth row (in FIG. 21, FIG. 22, FIG. 23 or FIG. 24, Pixel (n) is used to represent the sub-pixels in the nth row), and the second scanning signal line VR line in the nth row is electrically connected to the pixel driving circuit in the nth row.

In the at least one embodiment of the present application, the pixel driving circuit in mth row is a dummy pixel driving circuit (the pixel driving circuit disposed in the Dummy pixel row), m is a positive integer, m is greater than or equal to 1 and less than or equal to 4, equal to n+1 or n+2; the pixel driving circuit in the mth row is electrically connected to a shift register in the mth row.

It should be noted that the dummy pixel row can transmit the scanning signal, but it does not actually display the light.

In an embodiment of the present application, for the pixel driving circuit in the nth row, when n=5, the first scanning signal line is the gate line in the first row, the third scanning signal line is the gate line in the fifth row, and the fourth scanning signal line is the gate line in the third row. The fifth scanning signal line is the gate line in the seventh row. In order to make the pixel driving circuit in the fifth row drive normally, it is necessary to dispose 4 rows of dummy pixel driving rows and 4 rows of shift registers before the pixel driving circuit in the fifth row, so as to provide the scanning signals to the pixel driving circuits after the fifth row. In addition, for the pixel driving circuit in the last row (i.e., the nth row) that is actually used for displaying, since the fifth scanning signal provided by the gate line in the (n+2)th row is required, at least two rows of dummy pixel-driven rows and at least two rows of shift registers need to be disposed after the pixel row of the nth row to provide the scanning signal to the pixel driving circuits before the nth row.

In an embodiment of the present application, the pixel driving circuit can use the gate electrode driving signals provided by the gate lines in different rows to make the quantity of external signal lines required by the pixel driving circuit less. The type and quantity of the shift registers externally connected to the pixel driving circuits are significantly decreased (or when the external signals are provided by using the driver chips ICs, the quantity of ICs externally connected to the pixel driving circuits can be significantly decreased), the power consumption of the display apparatus is reduced to a great extent, and manufacturing a display apparatus with a narrow border frame is facilitated.

In the at least one embodiment of the present application, the first reset signal line includes a reference signal line Ref line, and the second reset signal line includes an initialization signal line Vinit line. An absolute value of a difference between a voltage Vref of a reference signal transmitted by the reference signal line Ref line and a voltage Vinit of an initialization signal transmitted by the initialization signal line Vinit line is greater than the threshold voltage (Vth) of the driving transistor.

In an embodiment of the present application, in a signal reset stage, the voltage of the first node NS is reset by the first reset sub-circuit 1 under the control of the first scanning signal VG(n−4). Additionally, under the control of the controlling signal (such as the first scanning signal VG(n−4) or the second scanning signal VR), while the voltage of the second node NG is reset by the first reset sub-circuit 1, by disposing that the absolute value of the difference between the voltage Vref of the reference signal transmitted by the reference signal line Ref line and the voltage Vinit of the initialization signal transmitted by the initialization signal line Vinit line is greater than the threshold voltage (Vth) of the driving transistor, that the driving transistor MD is in the on-state can be ensured. As shown in FIG. 1, FIG. 4, FIG. 5, FIG. 7 or FIG. 9, the electrodes electrically connected to the first capacitor C1 and the second capacitor C2 in the storing sub-circuit 6 can also be pre-charged to prevent the inability to complete threshold compensation in the compensation stage of the pixel driving circuit due to that the capacitance to be charged is large, thereby the compensation effect of the threshold voltage of the driving transistor in the subsequent compensation stage is improved.

In the exemplary embodiment, when the driving transistor MD is the N-type transistor, the voltage Vref of the reference signal transmitted by the reference signal line Ref line is greater than the voltage Vinit of the initialization signal transmitted by the initialization signal line Vinit line.

In the exemplary embodiment, when the driving transistor MD is the P-type transistor, the voltage Vref of the reference signal transmitted by the reference signal line Ref line is less than the voltage Vinit of the initialization signal transmitted by the initialization signal line Vinit line.

In the exemplary embodiment, the reference signal transmitted by the reference signal line Ref line is a signal with a constant voltage, and the initialization signal transmitted by the initialization signal line Vinit line is another signal with a constant voltage.

In the at least one embodiment of the present application, the first reset signal line includes the first power line VDD line (that is, the first pole of the second transistor M2 is electrically connected to the first power line VDD line). The second reset signal line includes the second power line VSS line (the first pole of the fourth transistor M4 is electrically connected to the second power line VSS line).

In an embodiment of the present application, by disposing that the first reset signal line includes the first power line VDD line and the second reset signal line includes the second power line VSS line, the quantity of external signal lines of the pixel driving circuit can be further reduced, the circuit and wiring design in the display apparatus can be simplified, the design space can be saved, and the difficulty of the preparation process can be reduced. The pixel driving circuit is beneficial to be applied to the display apparatus with a narrow border frame.

In the at least one embodiment of the present application, as shown in FIG. 1 or FIG. 7, the data writing sub-circuit 2 includes a first transistor M1, a gate electrode of the first transistor M1 is electrically connected to the third scanning signal line (the gate line in nth row); the first pole of the first transistor M1 is electrically connected to the data line Data line, the second pole of the first transistor M1 is electrically connected to the gate electrode of the driving transistor MD through the second node NG, and the first transistor M1 is configured to respond to the third scanning signal VG(n), transmit and write the data signal into the gate electrode of the driving transistor MD.

In the at least one embodiment of the present application, the switching transistors SW are also connected in series between the data lines Data line and the first transistors M1 of the pixel driving circuits (as shown in FIG. 25 or FIG. 26, the black rectangle represents the pixel driving circuit). The switch transistor SW is configured to write the data signal Vdata into the data line Data line before the first transistor M1 is turned on.

Exemplarily, as shown in FIG. 25, in order to improve the opening rate, the switching transistor SW is disposed at the junction of the displaying region and the binding area of the display apparatus, wherein the binding area is provided with a Source driver IC. All data lines Data are electrically connected to the Source driver IC through the switching transistors SW, and the Source driver IC is configured to provide the data signal to the displaying region of the display apparatus.

Exemplarily, as shown in FIG. 26, for a column of pixel driving circuits, a switching transistor SW can be shared between the first transistors M1 of a plurality of pixel driving circuits and the data line Data line. Taking the connection structure shown in FIG. 26 as an example, four pixel driving circuits can be electrically connected to the data line Data line through the same switch transistor SW. Before the first transistor M1 of each of the four pixel driving circuits is turned on, the data signal Vdata can be pre-written to the position of the first pole (or second pole) of the switch transistor SW by controlling the switch transistor SW. Thus, the transmission path and transmission time of the data signal are shortened.

It should be noted that the quantity of the switching transistors SW electrically connected to the same data line Data line is not limited here, which can be designed according to the design space and transmission time requirements of the data signal.

As shown in FIG. 26, when the same data line Data line is connected to a plurality of switching transistors SW, at least part of the switching transistors SW can be disposed in the displaying region AA, such as in the non-opening area of the displaying region AA.

Wherein, the opening area refers to the area where the light is actually displayed in the displaying region AA; the non-opening area refers to the area in the displaying region AA other than the opening area, which is usually used for wiring and disposing the circuit structure.

In the embodiments of the present application, the switch transistors SW are connected in series between the data line Data line and the first transistors M1 of the pixel driving circuits (the black rectangle in FIG. 25 represents the pixel driving circuit). The data signal Vdata can be written into the data line Data line in advance by switching on the switch transistor SW before the first transistor M1 is turned on. After the first transistor M1 is turned on, the data signal Vdata can be quickly written into the gate electrode of the driving transistor MD, thereby the time that the data signals Vdata are transmitted to the pixel driving circuits is shortened, the refresh speed and response speed of the pixel driving circuits are improved, and the display effect of the display apparatus is improved.

In the at least one embodiment of the present application, as shown in FIG. 4, when the controlling signal line includes the second scanning signal line (e.g. the VR line), the data writing sub-circuit 2 includes a first transistor M1 and a ninth transistor M9.

A gate electrode of the first transistor M1 is electrically connected to the third scanning signal line (the gate line in the nth row), a first pole of the first transistor M1 is electrically connected to the data line Data line, and a second pole of the first transistor M1 is electrically connected to a first pole of the ninth transistor M9. A gate electrode of the ninth transistor M9 is electrically connected to the second scanning signal line VR line. A second pole of the ninth transistor M9 is electrically connected to the second node NG (the second pole of the ninth transistor M9 is electrically connected to the gate electrode of the driving transistor MD through the second node NG).

In the exemplary embodiments, the type of the first transistor M1 and the type of the ninth transistor M9 are opposite. For example, the first transistor M1 is an N-type transistor, and the ninth transistor M9 is a P-type transistor. For another example, the first transistor M1 is a P-type transistor, and the ninth transistor M9 is an N-type transistor. The timing sequence diagram provided by the embodiment of the present application (such as the timing sequence diagram shown in FIG. 3) and the following description are illustrated by taking that the first transistor M1 is an N-type transistor and the ninth transistor M9 is a P-type transistor as an example.

In the exemplary embodiments, the first transistor M1 and the ninth transistor M9 are not simultaneously turned on at some time intervals, and the first transistor M1 and the ninth transistor M9 are simultaneously turned on at some time intervals.

In the at least one embodiment of the present application, as shown in FIG. 3, the third scanning signal VG(n) and the second scanning signal VR overlap in time.

As shown in FIG. 3 and FIG. 4, the first transistor M1 is turned on and the ninth transistor M9 is not turned on during the overlapping time period of the third scanning signal VG(n) and the second scanning signal VR.

In the exemplary embodiments, it can be controlled that the first transistor M1 is turned on and the ninth transistor M9 is turned off, so that the data signal Vdata transmitted in the data line Data line can be written in advance into the position between the first transistor M1 and the ninth transistor M9 as shown in FIG. 4. When the first transistor M1 and the ninth transistor M9 are simultaneously turned on, the data signal Vdata can be quickly written into the gate electrode of the driving transistor MD through the ninth transistor M9, thereby the transmission time of the data signal Vdata is shortened, the refresh speed and response speed of the pixel driving circuits are improved, the display effect of the display apparatus is improved.

In the at least one embodiment of the present application, as shown in FIG. 5, when the controlling signal line includes the second scanning signal line VR line, the data writing sub-circuit 2 includes the first transistor M1, the ninth transistor M9 and a tenth transistor M10.

A gate electrode of the first transistor M1 is electrically connected to the third scanning signal line (the gate line in the nth row), the first pole of the first transistor M1 is electrically connected to the data line Data line, and the second pole of the first transistor M1 is electrically connected to the first pole of the ninth transistor M9. The gate electrode of the ninth transistor M9 is electrically connected to the second scanning signal line VR line, and the second pole of the ninth transistor M9 is electrically connected to the second node NG. A first pole of the transistor M10 is electrically connected to the data line Data line, a second pole of the tenth transistor M10 is electrically connected to the first pole of the ninth transistor M9, and a gate electrode of the tenth transistor M10 is electrically connected to the sixth scanning signal line (the gate line in the (n−1)th row).

In the exemplary embodiment, the type of the first transistor M1 and the type of the ninth transistor M9 are opposite, and the type of the first transistor M1 and the type of the tenth transistor M10 are the same.

For example, the first transistor M1 is an N-type transistor, the ninth transistor M9 is a P-type transistor, and the tenth transistor M10 is an N-type transistor. For example, the first transistor M1 is a P-type transistor, the ninth transistor M9 is an N-type transistor, and the tenth transistor M10 is a P-type transistor. The timing sequence diagram (such as the timing sequence diagram shown in FIG. 6) provided by the embodiment of the present application and the following description are illustrated by taking that the first transistor M1 is an N-type transistor, the ninth transistor M9 is a P-type transistor, and the tenth transistor M10 is an N-type transistor as an example.

In the exemplary embodiment, the first transistor M1 and the ninth transistor M9 are turned on at the same time, and the tenth transistor M10 and the ninth transistor M9 are not turned on at the same time.

In the at least one embodiment of the present application, as shown in FIG. 6, the sixth scanning signal VG(n−1) and the second scanning signal VR overlap in time.

As shown in FIG. 5 and FIG. 6, the tenth transistor M10 is turned on and the ninth transistor M9 is not turned on during the overlapping time period of the sixth scanning signal VG(n−1) and the second scanning signal VR.

In the exemplary embodiment, it can be controlled that the tenth transistor M10 is turned on, and the ninth transistor M9 is turned off, so that the data signal Vdata transmitted in the data line Data line can be written in advance into the position between the tenth transistor M10 and the ninth transistor M9 as shown in FIG. 5. When the first transistor M1 and the ninth transistor M9 are simultaneously turned on, the data signal Vdata can be quickly written into the gate electrode of the driving transistor MD through the ninth transistor M9, thereby the transmission time of the data signal Vdata is shortened, the refresh speed and response speed of the pixel driving circuits are improved, and the display effect of the display apparatus is improved.

In the at least one embodiment of the present application, as shown in FIG. 9. When the controlling signal line includes the first scanning signal line VG(n−4), the data writing sub-circuit 2 includes the first transistor M1, the ninth transistor M9 and the tenth transistor M10.

The gate electrode of the first transistor M1 is electrically connected to the third scanning signal line VG(n), the first pole of the first transistor M1 is electrically connected to the data line Data line, and the second pole of first transistor M1 is electrically connected to the first pole of the ninth transistor M9. The gate electrode of the ninth transistor M9 is electrically connected to the sixth scanning signal line (the gate line in the (n−1)th row), and the second pole of the ninth transistor M9 is electrically connected to the second node NG. The gate electrode of the tenth transistor M10 is electrically connected to the sixth scanning signal line (the gate line in the (n−1)th row), the first pole of the tenth transistor M10 is electrically connected to the data line Data line, and the second pole of the tenth transistor M10 is electrically connected to the first pole of the ninth transistor M9.

In the exemplary embodiment, the type of the first transistor M1 and the type of the ninth transistor M9 are opposite, and the type of the first transistor M1 and the type of the tenth transistor M10 are the same.

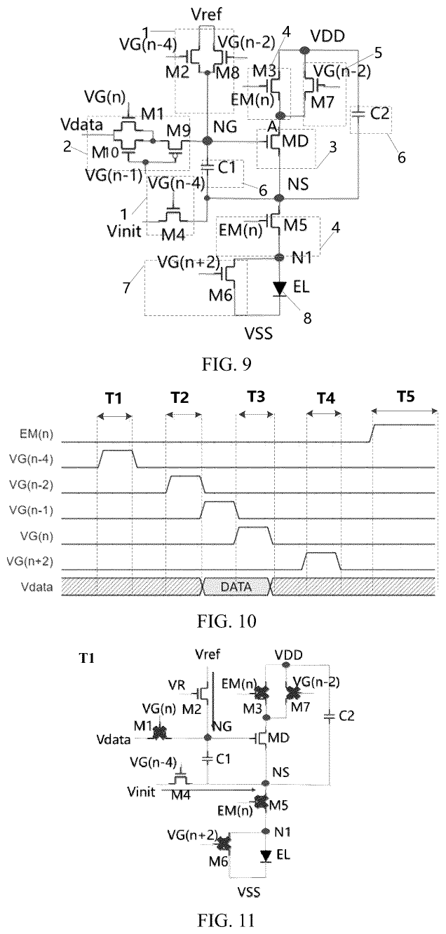

The timing sequence diagram (such as the timing sequence diagram shown in FIG. 10) provided by the embodiment of the present application and the following explanation are illustrated by taking that the first transistor M1 is an N-type transistor, the ninth transistor M9 is a P-type transistor and the tenth transistor M10 is an N-type transistor as an example.

As shown in FIG. 9 and FIG. 10, when the tenth transistor M10 is turned on, the ninth transistor M9 is turned off, so that the data signal Vdata transmitted in the data line Data line is written in advance into the position between the tenth transistor M10 and the ninth transistor M9 as shown in FIG. 9. When the first transistor M1 and the ninth transistor M9 are simultaneously turned on, the data signal Vdata can be quickly written into the gate electrode of the driving transistor MD through the ninth transistor M9, thereby the transmission time of the data signal Vdata is shortened, the refresh speed and response speed of the pixel driving circuits are improved, and the display effect of the display apparatus is improved.

In the at least one embodiment of the present application, the sixth scanning signal line is the gate line in the (n−1)th row, as shown in FIG. 10, the pulse width of the scanning signal loaded on the sixth scanning signal line is the same as the pulse width of the scanning signal loaded on the first scanning signal line (the gate line in the (n−4)th row).

It should be noted that the pulse width of the first scanning signal VG(n−4), the pulse width of the third scanning signal VG(n), the pulse width of the fourth scanning signal VG(n−2), the pulse width of the fifth scanning signal VG(n+2) and the pulse width of the sixth scanning signal VG(n−1) drawn in FIG. 10 are only schematic descriptions and do not represent the actual pulse widths. In practical applications, the pulse width of the scanning signal on the first scanning signal VG(n−4), the pulse width of the scanning signal on the third scanning signal VG(n), the pulse width of the scanning signal on the fourth scanning signal VG(n−2), the pulse width of the scanning signal on the fifth scanning signal VG(n+2) and the pulse width of the scanning signal on the sixth scanning signal VG(n−1) are the same.

As shown in FIG. 21, FIG. 22, FIG. 23 or FIG. 24, the first scanning signal VG(n−4), the third scanning signal VG(n), the fourth scanning signal VG(n−2), the fifth scanning signal VG(n+2) and the sixth scanning signal VG(n−1) are all generated by the shift registers (GOA).

In the at least one embodiment of the present application, as shown in FIG. 1, FIG. 3, FIG. 4 and FIG. 5, when the controlling signal line includes the second scanning signal line VR line, the first reset sub-circuit 1 includes the second transistor M2 and the fourth transistor M4.

A gate electrode of the second transistor M2 is electrically connected to the second scanning signal line VR line, and a first pole of the second transistor M2 is electrically connected to the second reset signal line (such as the Vref line), a second pole of the second transistor M2 is electrically connected to the second node NG. A gate electrode of the fourth transistor M4 is electrically connected to the first scanning signal line (for example, the gate line in the (n−4)th row), a first pole of the fourth transistor M4 is electrically connected to the first reset signal line (for example, the Vinit line), and a second pole of the fourth transistor M4 is electrically connected to the first node NS.

In the exemplary embodiments, as shown in FIG. 1, FIG. 3, FIG. 4 and FIG. 5, the second transistor M2 stated above responds to the second scanning signal VR under the control of the second scanning signal VR transmitted by the second scanning signal line (for example, the VR line), and resets the voltage of the second node NG electrically connected to the gate electrode of the driving transistor MD through the resetting signal (for example, the reference signal Vref) transmitted by the second reset signal line (for example, the Ref line).

In an exemplary embodiment, under the control of the first scanning signal (for example, the VG(n−4) signal) transmitted by the first scanning signal line (for example, the gate line in the (n−4)th row), the fourth transistor M4 responds to the first scanning signal and resets the first node NS electrically connected to the second pole of the driving transistor MD through the first resetting signal (for example, the Vinit signal) transmitted by the first reset signal line (for example, the Vinit line).

In the at least one embodiment of the present application, as shown in FIG. 7 and FIG. 9, when the controlling signal line includes the first scanning signal line (for example, the gate line in the (n−4)th row), the first reset sub-circuit 1 includes the second transistor M2, the fourth transistor M4 and the eighth transistor M8.

The gate electrode of the second transistor M2 and the gate electrode of the fourth transistor M4 are electrically connected to the first scanning signal line (for example, the gate line in the (n−4)th row), the first pole of the second transistor M2 is electrically connected to the second reset signal line (for example, the Vref line), the second pole of the second transistor M2 is electrically connected to the second node NG. The first pole of the fourth transistor M4 is electrically connected to the first reset signal line (for example, the Vinit line). The second pole of the fourth transistor M4 is electrically connected to the first node NS. A gate electrode of the eighth transistor M8 is electrically connected to the fourth scanning signal line (for example, the gate line in the (n−2)th row), a first pole of the eighth transistor M8 is electrically connected to the second reset signal line (such as the Vref line), and a second pole of the eighth transistor M8 is electrically connected to the second node NG.

In the exemplary embodiment, as shown in FIG. 7 and FIG. 9, under the control of the first scanning signal VG(n−4) transmitted by the first scanning signal line (for example, the gate line in the (n−4)th row), the second transistor M2 responds to the first scanning signal VG(n−4), and resets the voltage of the second node NG electrically connected to the gate electrode of the driving transistor MD through the resetting signal (for example, the reference signal Vref) transmitted by the second reset signal line (for example, the ref line).

In an exemplary embodiment, under the control of the first scanning signal VG(n−4) transmitted by the first scanning signal line (for example, the gate line in the (n−4)th row), the fourth transistor M4 responds to the first scanning signal, and resets the first node NS electrically connected to the second pole of the driving transistor MD through the first resetting signal (for example, the Vinit signal) transmitted by the first reset signal line (for example, the Vinit line).

In an embodiment of the present application, before refreshing (re-writing new signals) the pixel driving circuits in sub-pixels of a row, key nodes (such as the first node NS electrically connected to the source electrode of the driving transistor MD and the second node NG electrically connected to the gate electrode of the driving transistor MD) in the pixel driving circuits can be reset through the second transistor M2 and the fourth transistor M4 to eliminate residual signals from the previous frame, prevent ghosts from appearing in the next display frame. When the pixel driving circuits are applied in a display apparatus, the display effect of the display apparatus can be improved.

In the at least one embodiment of the present application, as shown in FIG. 1, FIG. 4, FIG. 5, FIG. 7 and FIG. 9, the light emitting controlling sub-circuit 4 includes a third transistor M3 and a fifth transistor M5.

A gate electrode of the third transistor M3 and a gate electrode of the fifth transistor M5 are connected to the light emitting controlling signal line EM(n) line, a first pole of the third transistor M3 is electrically connected to the first power line VDD line, and a second pole of the third transistor M3 is electrically connected to the third node A. A first pole of the fifth transistor M5 is electrically connected to the first node NS, and a second pole of the fifth transistor M5 is electrically connected to the anode N1.

In the exemplary embodiment, the third transistor M3 is configured to transmit the first power signal VDD of the first power line VDD line to the first pole (for example, the source electrode) of the driving transistor MD through the third node A under the control of the light-emitting controlling signal EM(n) transmitted by the light-emitting controlling signal line EM(n) line. The fifth transistor M5 is configured to transmit the driving current generated by the driving transistor MD to the anode N1 of the light-emitting device 8 under the control of the light-emitting controlling signal EM(n) transmitted by the light-emitting controlling signal line EM(n) line.

In the at least one embodiment of the present application, as shown in FIG. 1, FIG. 4, FIG. 5, FIG. 7 and FIG. 9, the compensating sub-circuit 5 includes a seventh transistor M7. A gate electrode of the seventh transistor M7 is electrically connected to the fourth scanning signal line (for example, the gate line in the (n−2)th row), a first pole of the seventh transistor M7 is electrically connected to the first power line VDD line, and a second pole of the seventh transistor M7 is electrically connected to the third node A.

In cooperation with the eighth transistor M8, that is, when the seventh transistor M7 and the eighth transistor M8 are turned on at the same time, the first capacitor C1 can keep that the potential of the second node NG is still Vref, the driving transistor MD is kept in the on-state, and a pathway is formed between the first power line VDD line and the first node NS. The first power line VDD line charges the first node NS. When the potential of the first node NS becomes Vref−Vth, the driving transistor MD is turned off. Because the process changes slowly, and the potential of the second node NG is always pulled by the Vref. Therefore, the potential of the second node NG is kept as the Vref, at this moment, Vgs=Vref−(Vref−Vth)=Vth, thus the extraction of the threshold voltage Vth of the driving transistor MD is completed.

In the at least one embodiment of the present application, as shown in FIG. 1, FIG. 4, FIG. 5, FIG. 7 and FIG. 9, the storing sub-circuit 6 includes a first capacitor C1 and a second capacitor C2.

A first electrode of the first capacitor C1 is electrically connected to the second node NG, and a second electrode of the first capacitor C1 is electrically connected to the first node NS. A first electrode of the second capacitor C2 is electrically connected to the first power line VDD line, and a second electrode of the second capacitor C2 is electrically connected to the second electrode of the first capacitor C1 through the first node NS.

Here, a capacitance value of the first capacitor C1 and a capacitance value of the second capacitor C2 are not limited.

In some embodiments, the driving current of the driving transistor MD can be adjusted by adjusting a ratio of the capacitance value of the first capacitor C1 to the capacitance value of the second capacitor C2.

In some other embodiments, in order to have a small effect on the voltage of the gate electrode of the driving transistor MD when the voltage value of the data signal Vdata changes greatly, thus the driving current of the driving transistor MD is less affected (that is, the driving current of the driving transistor MD changes less), the capacitance value of the first capacitor C1 can be set to be greater than the capacitance value of the second capacitor C2.

In an embodiment of the present application, the voltage of the second node NG can be stabilized by disposing the first capacitor C1, and the voltage of the first node NS can be stabilized by disposing the second capacitor C2. By adjusting the ratio of the capacitance value of the first capacitor C1 to the capacitance value of the second capacitor C2, it can be realized that the change caused by the greatly changed data signal Vdata of the driving current is small, thus a more accurate control for the driving current is achieved, a more precise adjustment and display of the display gray scale of the display apparatus is achieved, and the display effect of the display apparatus is improved.

In the at least one embodiment of the present application, as shown in FIG. 1, FIG. 4, FIG. 5, FIG. 7 and FIG. 9, the second reset sub-circuit 7 includes a sixth transistor M6. A gate electrode of the sixth transistor M6 is electrically connected to the fifth scanning signal line (for example, the gate line in the (n+2)th row), and a first pole of the sixth transistor M6 is electrically connected to the anode N1, and a second pole of the sixth transistor M6 is electrically connected to the second power line VSS line and the cathode of the light emitting device 8, respectively.

In the exemplary embodiment, the sixth transistor M6 is configured to transmit the second power signal VSS transmitted by the second power line VSS line to the anode of the light emitting device 8 under the control of the fifth scanning signal transmitted by the fifth scanning signal line (for example, the gate line in the (n+2)th row). Thus, the anode of the light emitting device 8 can be reseted via the second power line VSS line before the light emitting device 8 emits light.

Exemplarily, the second power line VSS line can be electrically connected to the ground end GND.

In the at least one embodiment of the present application, when the data writing sub-circuit 2 includes the ninth transistor M9, a type of the ninth transistor M9 is opposite to types of the other transistors.

In the at least one embodiment of the present application, as shown in FIG. 1, FIG. 4, FIG. 5, FIG. 7 and FIG. 9, the ninth transistor is a P-type transistor, and the other transistors are N-type transistors.

In the at least one embodiment of the present application, when the driving transistor is an N-type transistor, the voltage Vref of the reference signal is greater than the voltage Vinit of the initialization signal, and the absolute value of the difference between the voltage Vref of the reference signal and the voltage Vinit of the initialization signal is in a range of 2V to 4V.

Exemplarily, the absolute value of the difference between the voltage Vref of the reference signal and the voltage Vinit of the initialization signal is 2.3V, 2.5V, 2.8V, 3V, 3.3V, 3.5V, or 3.8V.

In an embodiment of the present application, during the signal reset stage, by setting that the absolute value of the difference between the voltage Vref of the reference signal and the voltage Vinit of the initialization signal is in the range of 2V to 4V, it can be ensured that the driving transistor MD is in an on-state, and it can also pre-charge the electrodes electrically connected to the first capacitor C1 and the second capacitor C2 in the storing sub-circuit 6 to prevent the threshold voltage compensation from being unable to be completed due to that the capacitance to be charged is large in the compensation stage of pixel driving circuit, the compensation effect of the threshold voltage of the driving transistor in the subsequent compensation stage is improved.

In the at least one embodiment of the present application, the capacitance value of the second capacitor C2 is less than the capacitance value of the first capacitor C1.

In an embodiment of the present application, by setting that the capacitance value of the second capacitor C2 is less than the capacitance value of the first capacitor C1, it can be realized that the change caused by the greatly changed data signal Vdata of the driving current is small. When the low-resolution Source IC in the related art is used, thus a more accurate control for the driving current is achieved, a more precise adjustment and display of the display gray scale of the display apparatus is achieved, and the display effect of the display apparatus is improved.

In the at least one embodiment of the present application, for the pixel driving circuit shown in FIG. 1, all of the first transistor M1, the second transistor M2, the fourth transistor M4 and the fifth transistor M5 can be set to be double-gate transistors, two gate electrodes of a same transistor are electrically connected together; or all of the first transistor M1, the second transistor M2, the fourth transistor M4, and the fifth transistor M5 are metal oxide transistors.

In the at least one embodiment of the present application, for the pixel driving circuits shown in FIG. 4 and FIG. 5, all of the ninth transistor M9, the second transistor M2, the fourth transistor M4 and the fifth transistor M5 can be set to be double-gate transistors, two gate electrodes of a same transistor are electrically connected together; or, all of the ninth transistor M9, the second transistor M2, the fourth transistor M4 and the fifth transistor M5 are metal oxide transistors.

In the at least one embodiment of the present application, for the pixel driving circuit shown in FIG. 7, all of the first transistor M1, the second transistor M2, the eighth transistor M8, the fourth transistor M4 and the fifth transistor M5 can be set to be double-gate transistors, two gate electrodes of a same transistor are electrically connected together; or, all of the first transistor M1, the second transistor M2, the eighth transistor M8, the fourth transistor M4 and the fifth transistor M5 are metal oxide transistors.

In the at least one embodiment of the present application, for the pixel driving circuit shown in FIG. 9, all of the ninth transistor M9, the second transistor M2, the eighth transistor M8, the fourth transistor M4 and the fifth transistor M5 can be set to be double-gate transistors, two gate electrodes of a same transistor are electrically connected together; or, all of the ninth transistor M9, the second transistor M2, the eighth transistor M8, the fourth transistor M4 and the fifth transistor M5 are metal oxide transistors.

In an embodiment of the present application, during the operating process of the pixel circuit, the transistor and the light emitting device may inevitably leak currents, thus the compensation and luminescence effect are affected. Therefore, the transistors around the key nodes (such as the transistors around the NS node and the NG node) can be set to be double-gate transistors, or set to be metal oxide transistors, which can significantly reduce the leakage current of the transistors around the key nodes, thereby the display effect of the display apparatus is improved.

In the at least one embodiment of the present application, the driving transistor MD is a double-gate transistor, and one gate electrode of the driving transistor MD is electrically connected to the second node NG, and the other gate electrode of the driving transistor MD is electrically connected to the signal input end with a constant voltage. The constant voltage is less than the threshold voltage of the driving transistor MD.

In an embodiment of the present application, one gate electrode of the driving transistor MD is electrically connected to the second node NG to control the on-state and off-state of the driving transistor MD. The other gate electrode of the driving transistor is electrically connected to a signal input end with a constant voltage to stabilize the threshold voltage of the driving transistor MD and improve the driving stability of the driving transistor MD, wherein the voltage provided by the signal input end with a constant voltage cannot interfere the on-state and off-state of the driving transistor MD. Therefore, the absolute value of the constant voltage is set to be less than the absolute value of the threshold voltage of the driving transistor MD.

In the at least one embodiment of the present application, the light emitting device 8 includes an organic light-emitting diode (OLED), a Micro LED (Micro Light-Emitting Diode) or a Mini LED (Mini Light-Emitting Diode).

A display apparatus is provided by the embodiment of the present application, which includes a pixel driving circuit according to any one of embodiments stated above.

The above display apparatus can be organic light-emitting diode (OLED) display apparatus, Micro LED (Micro Light-Emitting Diode) display apparatus or Mini LED (Mini Light-Emitting Diode) display apparatus.

The display apparatus may include any device or product with a display function. For example, the display apparatus may be smart phones, mobile phones, e-book readers, desktop computers (PCs), laptop PCs, netbook PCs, personal digital assistants (PDAs), portable multimedia players (PMPs), digital audio players, mobile medical devices, cameras, wearable devices (such as head-mounted devices, electronic clothing, electronic bracelets, electronic necklaces, electronic accessories, electronic tattoos, or smart watches), televisions, etc.

The display apparatus, which is provided by the embodiment of the present application, includes the pixel driving circuits described above, due to the setting of transistors, capacitors and timing sequence signals in the pixel driving circuits, the anode of the light emitting device 8 can be separated from the second pole (for example, the source electrode) of the driving transistor MD, the light emitting device 8 itself (the drift of the threshold voltage, the coupling of its capacitance in the circuit) does not affect the potential change of the source electrode of the driving transistor MD before the light emitting stage. At the same time, the second capacitor C2 is set to ensure the stability of the potential of the NS node and ensure the compensation effect. In addition, by setting the ratio of the capacitance of C2 to the capacitance of C1, the pixel driving circuits can achieve richer gray-scale display when driving the Micro LED light emitting device and the Mini LED light emitting device. Finally, the pixel driving circuits can use the gate electrode driving signals provided by the gate lines in different rows, so that the quantity of external signal lines required is small. The type and quantity of the shift registers externally connected to the pixel driving circuits are significantly decreased (or when the external signals are provided by using the driver chips ICs, the quantity of ICs externally connected to the pixel driving circuits can be significantly decreased), the power consumption of the display apparatus is reduced to a great extent, and manufacturing a display apparatus with a narrow border frame is facilitated.

As shown in FIG. 1 and FIG. 21, the pixel driving circuits can use four gate lines in different rows (the gate line in the nth row, the gate line in the (n−2)th row, the gate line in the (n−4)th row and the gate line in the (n+2)th row), so that the quantity of the external signal lines is reduced to six (including the Data line, the VR line, the Vref line, the Vinit line, the VDD line and the VSS line). When the VDD line is used to replace the Vref line, and the VSS line is used to replace the Vinit line, the quantity of the external signal lines is reduced to 4.

Exemplarily, as shown in FIG. 4 and FIG. 1, the condition that the gate lines can be used by the pixel driving circuits is the same as the condition the external signal lines can be used by the pixel driving circuits.

Exemplarily, in combination with FIG. 5 and FIG. 23, the pixel driving circuits can use five gate lines in different rows (the gate line in the nth row, the gate line in the (n−1)th row, the gate line in the (n−2)th row, the gate line in the (n−4)th row and the gate line in the (n+2)th row), so that the quantity of the external signal lines is reduced to six (including the Data line, the VR line, the Vref line, the Vinit line, the VDD line and the VSS line). When the VDD line is used to replace the Vref line, and the VSS line is used to replace the Vinit line, the quantity of the external signal lines is reduced to 4.

Exemplarily, in combination with FIG. 7 and FIG. 22, the pixel driving circuits can use four gate lines in different rows (the gate line in the nth row, the gate line in the (n−2)th row, the gate line in the (n−4)th row and the gate line in the (n+2)th row), so that the quantity of the external signal lines is reduced to five (including the Data line, the Vref line, the Vinit line, the VDD line and the VSS line). When the VDD line is used to replace the Vref line, and the VSS line is used to replace the Vinit line, the quantity of the external signal lines is reduced to 3.

Exemplarily, in combination with FIG. 9 and FIG. 24, the pixel driving circuits can use five gate lines in different rows (the gate line in the nth row, the gate line in the (n−1)th row, the gate line in the (n−2)th row, the gate line in the (n−4)th row and the gate line in the (n+2)th row), so that the quantity of the external signal lines is reduced to five (including the Data line, the Vref line, the Vinit line, the VDD line and the VSS line). When the VDD line is used to replace the Vref line, and the VSS line is used to replace the Vinit line, the quantity of the external signal lines is reduced to 3.

In this way, the signal crosstalk in the operating process of the pixel driving circuits is reduced, and the operating reliability is optimized. At the same time, the reduction of the quantity of the external signals also saves power consumption and wiring space, so that the pixel driving circuits are more suitable for the display apparatus with the narrow border frame.

A driving method is provided by the embodiment of the present application, which is applied to the pixel driving circuits according to any one of embodiments, the driving method includes:

S801, in a first stage, such as the T1 stage shown in FIG. 2, FIG. 3, FIG. 6 and FIG. 8, inputting a low level light emitting controlling signal EM(n) to the light emitting controlling signal line, inputting a high level first scanning signal VG(n−4) to the first scanning signal line, inputting a low level fourth scanning signal VG(n−2) to the fourth scanning signal line, inputting a low level third scanning signal VG(n) to the third scanning signal line, and inputting a low level fifth scanning signal VG(n+2) to the fifth scanning signal line;

S802, in a second stage, such as the T2 stage shown in FIG. 2, FIG. 3, FIG. 6 and FIG. 8, inputting the low level light emitting controlling signal EM(n) to the light emitting controlling signal line, inputting a low level first scanning signal VG(n−4) to the first scanning signal line, inputting a high level fourth scanning signal VG(n−2) to the fourth scanning signal line, inputting the low level third scanning signal VG(n) to the third scanning signal line, and inputting the low level fifth scanning signal VG(n+2) to the fifth scanning signal line;

S803, in a third stage, such as the T3 stage shown in FIG. 2, FIG. 3, FIG. 6 and FIG. 8, inputting the low level light emitting controlling signal EM(n) to the light emitting controlling signal line, inputting the low level first scanning signal VG(n−4) to the first scanning signal line, inputting the low level fourth scanning signal VG(n−2) to the fourth scanning signal line, inputting a high level third scanning signal VG(n) to the third scanning signal line, and inputting the low level fifth scanning signal VG(n+2) to the fifth scanning signal line;

S804, in a fourth stage, such as the T4 stage shown in FIG. 2, FIG. 3, FIG. 6 and FIG. 8, inputting the low level light emitting controlling signal EM(n) to the light emitting controlling signal line, inputting the low level first scanning signal VG(n−4) to the first scanning signal line, inputting the low level fourth scanning signal VG(n−2) to the fourth scanning signal line, inputting the low level third scanning signal VG(n) to the third scanning signal line, and inputting a high level fifth scanning signal VG(n+2) to the fifth scanning signal line; and

S805, in a fifth stage, such as the T5 stage shown in FIG. 2, FIG. 3, FIG. 6 and FIG. 8, inputting a high level light emitting controlling signal EM(n) to the light emitting controlling signal line, inputting the low level first scanning signal VG(n−4) to the first scanning signal line, inputting the low level fourth scanning signal VG(n−2) to the fourth scanning signal line, inputting the low level third scanning signal VG(n) to the third scanning signal line, and inputting the low level fifth scanning signal VG(n+2) to the fifth scanning signal line.

The drift problem of the threshold voltage of the driving transistor can be improved in the process of driving the circuit according to the driving method of the pixel driving circuits provided by the embodiment of the present application. Due to the anode of the light emitting device 8 in the pixel driving circuits is separated from (not directly electrically connected to) the second pole (for example, the source electrode) of the driving transistor MD, the light emitting device 8 itself (the drift of the threshold voltage, the coupling of its capacitance in the circuit) does not affect the potential change of the source electrode of the driving transistor MD before the light emitting stage. At the same time, the second capacitor C2 is set to ensure the stability of the potential of the NS node and ensure the compensation effect. In addition, by setting the ratio of the capacitance of C2 to the capacitance of C1, the pixel driving circuits can achieve richer gray-scale display when driving the Micro LED light emitting device and the Mini LED light emitting device. Finally, the pixel driving circuits can use the gate electrode driving signal provided by the gate lines in different rows, so that the quantity of external signal lines required is small. The type and quantity of the shift registers externally connected to the pixel driving circuits are significantly decreased and manufacturing a display apparatus with a narrow border frame is facilitated.

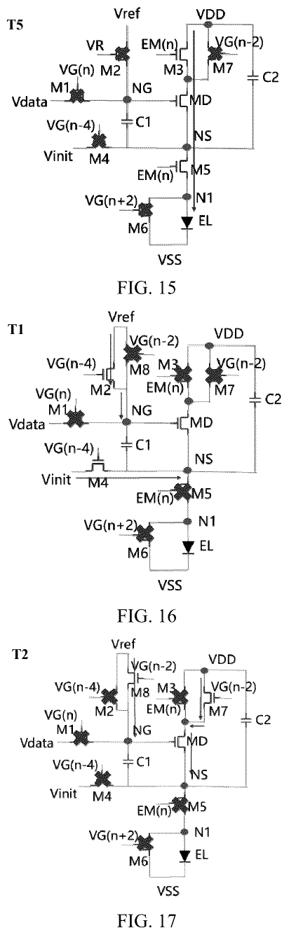

Taking the circuit diagram shown in FIG. 1 and that all transistors are N-type transistors as an example, the driving principle and the driving process of the driving circuit are described in detail. FIG. 2 provides the timing sequence corresponding to the circuit diagram in FIG. 1. FIG. 11 to FIG. 15 provide the circuit states of the circuit diagram in FIG. 1 in different stages of the timing sequence shown in FIG. 2. In FIG. 11 to FIG. 15, the transistor cutoff is marked by “x”.

In the first stage (reset stage), such as the T1 stage shown in FIG. 2, the low level light emitting controlling signal EM(n) is input to the light emitting controlling signal line, the high level first scanning signal VG(n−4) is input to the first scanning signal line, the low level fourth scanning signal VG(n−2) is input to the fourth scanning signal line, the low level third scanning signal VG(n) is input to the third scanning signal line, the low level fifth scanning signal VG(n+2) is input to the fifth scanning signal line, and the high level second scanning signal VR is input to the second scanning signal line.

At this moment, in combination with FIG. 2 and FIG. 11, the second transistor M2 and the fourth transistor M4 are turned on, the potential of the first node NS is the Vinit, and the potential of the second node NG is the Vref. Since both the Vref and the Vinit are high level potentials with constant voltages, the driving transistor MD is turned on. In this way, the resetting of the potential of the first node NS and the potential of the second node NG is completed. In addition, the electrodes (electrode plates) connected to the first capacitor C1 and the second capacitor C2 are pre-charged to prevent the extraction and compensation of the threshold voltage from being completed due to that the capacitance to be charged is large in the subsequent threshold voltage extraction stage.

In the second stage (the threshold voltage extraction stage), such as the T2 stage shown in FIG. 2, the low level light emitting controlling signal EM(n) is input to the light emitting controlling signal line, the low level first scanning signal VG(n−4) is input to the first scanning signal line, the high level fourth scanning signal VG(n−2) is input to the fourth scanning signal line, the low level third scanning signal VG(n) is input to the third scanning signal line, the low level fifth scanning signal VG(n+2) is input to the fifth scanning signal line and the high level second scanning signal VR is input to the second scanning signal line.

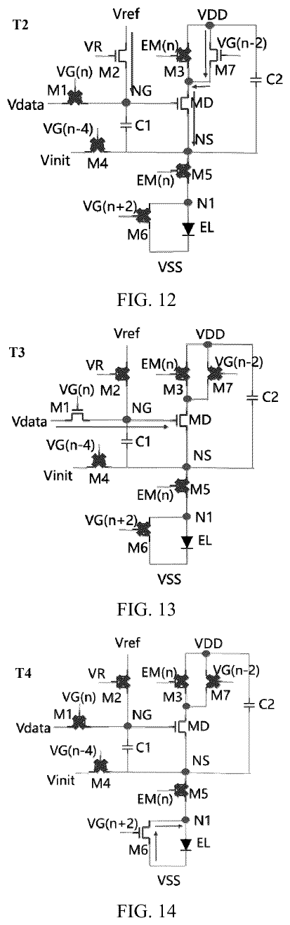

At this moment, in combination with FIG. 2 and FIG. 12, the second transistor M2 and the seventh transistor M7 are turned on, the first capacitor C1 can keep that the potential of the second node NG is still the Vref, the driving transistor MD is kept in the on-state, and a pathway is formed between the first power line VDD line and the first node NS. The first power line VDD line charges the first node NS. When the potential of the first node NS becomes Vref−Vth, the driving transistor MD is turned off. Because the process changes slowly, and the potential of the second node NG is always pulled by the Vref, Therefore, the potential of the second node NG is kept as Vref, at this moment, Vgs=Vref−(Vref−Vth)=Vth, thus the extraction of the threshold voltage Vth of the driving transistor MD is completed.

In the third stage, (the data writing and compensation stage), such as the T3 stage shown in FIG. 2, the low level light emitting controlling signal EM(n) is input to the light emitting controlling signal line, the low level first scanning signal VG(n−4) is input to the first scanning signal line, the low level fourth scanning signal VG(n−2) is input to the fourth scanning signal line, the high level third scanning signal VG(n) is input to the third scanning signal line, the low level fifth scanning signal VG(n+2) is input to the fifth scanning signal line and the low level second scanning signal VR is input to the second scanning signal line.

At this moment, in combination with FIG. 2 and FIG. 13, the first transistor M1 is turned on, the potential of the second node NG is the Vdata, and the driving transistor MD is turned on. Since the potential of the second node NG changes from the Vref in the previous stage to the Vdata, the potential of the first node NS changes to be (Vdata−Vref)*C1/(C1+C2)+Vref−Vth due to the coupling of the capacitance, wherein C1 and C2 represent the capacitance value of the first capacitor and the capacitance value of the second capacitor. In addition, since the fifth transistor M5 is turned off at this moment, in the second stage and the third stage, the potential of the first node NS will not be interfered by the potential of the anode of the light emitting device 8 and the IR Rise of the VSS.

In the fourth stage (reset stage), such as the T4 stage shown in FIG. 2, the low level light emitting controlling signal EM(n) is input to the light emitting controlling signal line, the low level first scanning signal VG(n−4) is input to the first scanning signal line, the low level fourth scanning signal VG(n−2) is input to the fourth scanning signal line, the low level third scanning signal VG(n) is input to the third scanning signal line, the high level fifth scanning signal VG(n+2) is input to the fifth scanning signal line, and the low level second scanning signal VR is input to the second scanning signal line.

At this moment, in combination with FIG. 2 and FIG. 14, the sixth transistor M6 is turned on. In addition, under the action of the first capacitor C1, the potential of the second node NG remains the Vdata, and the driving transistor MD is turned on. The potential of the second power line VSS line is written into the anode N1 of the light emitting device 8 through the sixth transistor M6, so as to reset the potential of the anode N1, thus negative effects caused by uneven potential of the anode of the light-emitting device due to factors such as manufacturing procedure on the operating current of pixels during the light emitting stage are prevented. In addition, since the fifth transistor M5 is turned off at this moment, the reseting of the potential of the anode N1 of the light emitting device will not affect the potential of the first node NS that has been compensated, the compensation effect of the threshold voltage Vth of the driving transistor MD is ensured.

In the fifth stage (light emitting stage), such as the T5 stage in FIG. 2, the high level light emitting controlling signal EM(n) is input to the light emitting controlling signal line, and the low level first scanning signal VG(n−4) is input to the first scanning signal line, the low level fourth scanning signal VG(n−2) is input to the fourth scanning signal line, the low level third scanning signal VG(n) is input to the third scanning signal line, the low level fifth scanning signal VG(n+2) is input to the fifth scanning signal line, and the low level second scanning signal VR is input to the second scanning signal line.

At this moment, in combination with FIG. 2 and FIG. 18, the third transistor M3 and the fifth transistor M5 are turned on. Due to the action of the first capacitor C1, the potential of the second node NG remains the Vdata, and the driving transistor MD is turned on, a pathway between the first power line VDD line and the second power line VSS line is formed. The Light emitting device 8 (EL) emits light.

$$Since V g = V data , V s = [ C 1 ( V data - V ref ) / ( C 1 + C 2 ) + V ref - V th ] ;$$

$$V gs = V data - [ C 1 ( V data - V ref ) / ( C 1 + C 2 ) + V ref - V th ] ;$$

$$Ids = {k ( V gs - V th )}^{2} = {k [ C 2 ( V data - V ref ) / ( C 1 + C 2 ) ]}^{2} ;$$

wherein k is a device parameter, and a carrier mobility and a channel width-to-length ratio of the driving transistor are related to the capacitance of the driving transistor. It can be seen that in the light emitting stage, the size of the driving current Ids is independent of the threshold voltage Vth, the voltage of the first power supply signal VDD and the voltage of the second power supply signal VSS, thus the pixel driving circuit can avoid the difference of potential changes caused by the uneven threshold voltage Vth of the driving transistor MD, the difference of resistance between the first power line VDD line and the second power line VSS line in different sub-pixels, so as to avoid the problem of uneven display frame of different regions in the display apparatus and improve the display effect.

Taking the circuit diagram shown in FIG. 4 as an example, taking that the ninth transistor M9 is the P-type transistor and other transistors are the N-type transistors as an example, the driving principle and the driving process of the driving circuit are described in detail. FIG. 3 provides the timing sequence corresponding to the circuit diagram in FIG. 4.

It should be noted that in the first stage T1, the second stage T2, the fourth stage T4 and the fifth stage T5, the driving principle and the driving process of the circuit diagram shown in FIG. 4 are the same as the driving principle and the driving process of the circuit diagram shown in FIG. 1 above. The driving process of the third stage T3 is introduced and explained in detail below.

In the third stage (data writing and compensation stage), such as the T3 stage shown in FIG. 4, the first transistor M1 and the ninth transistor M9 are turned on at the same time, and the potential of second node NG is the Vdata, the driving transistor MD is turned on. Since the potential of the second node NG changes from the Vref in the previous stage to the Vdata, the potential of the first node NS changes to be (Vdata−Vref)*C1/(C1+C2)+Vref−Vth due to the coupling of the capacitor, wherein C1 and C2 represent the capacitance value of the first capacitor and the capacitance value of the second capacitor. In addition, since the fifth transistor M5 is turned off at this moment, the potential of the first node NS will not be interfered by the potential of the anode of the light emitting device 8 and the IR Rise of the VSS in the second stage and the third stage.

It should be noted that since before the third stage, such as the T3 stage shown in FIG. 4, the high level third scanning signal VG(n) is input to the third scanning signal line in advance, the first transistor M1 has been turned on before the ninth transistor M9 is turned on, the data signal Vdata transmitted by the data line Data line is written in advance into the position between the first transistor M1 and the ninth transistor M9, when the first transistor M1 and the ninth transistor M9 are turned on at the same time, the data signal Vdata can be quickly written into the gate electrode of the driving transistor MD through the ninth transistor M9. Therefore, the transmission time of the data signal Vdata is shortened, the refresh speed and response speed of the pixel driving circuits are improved, and the display effect of the display apparatus is improved.

Taking the circuit diagram shown in FIG. 5 as an example, taking that the ninth transistor M9 is the P-type transistor and other transistors are the N-type transistors as an example, the driving principle and the driving process of the driving circuit are described in detail. FIG. 6 provides the timing sequence corresponding to the circuit diagram in FIG. 5.

It should be noted that in the first stage T1, the second stage T2, the fourth stage T4 and the fifth stage T5, the driving principle and the driving process of the circuit diagram shown in FIG. 4 are the same as the driving principle and the driving process of the circuit diagram shown in FIG. 1 above. The driving process of the third stage T3 is only introduced and explained in detail below.

In combination with FIG. 5 and FIG. 6, after the T2 stage and before the T3 stage, the high level second scanning signal VR is input to the second scanning signal line, the high level sixth scanning signal VG(n−1) is input to the sixth scanning signal line, the tenth transistor M10 is turned on, and the ninth transistor M9 is turned off. Thus, the data signal Vdata transmitted by the data line Data line is written in advance into the position between the tenth transistor M10 and the ninth transistor M9.

In the T3 stage, the low level second scanning signal VR is input to the second signal scanning line, the high level third scanning signal VG(n) is input to the third signal scanning line, the first transistor M1 and the ninth transistor M9 are turned on at the same time. The data signal Vdata can be quickly written into the gate electrode of the driving transistor MD through the ninth transistor M9, thus the transmission time of the data signal Vdata is shortened, the refresh speed and response speed of the pixel driving circuits are improved, and the display effect of the display apparatus is improved.

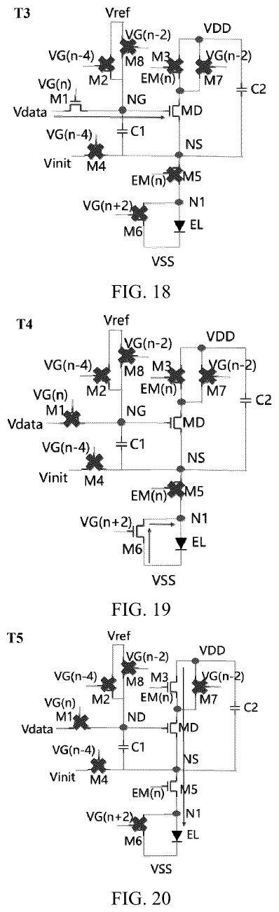

Taking the circuit diagram shown in FIG. 7 and that each transistor is an N-type transistor as an example, the driving principle and the driving process of the driving circuit are explained in detail. FIG. 8 provides the timing sequence corresponding to the circuit diagram in FIG. 7. FIG. 16 to FIG. 20 provide the circuit states of the circuit diagram in FIG. 7 in different stages of the timing sequence shown in FIG. 8. In FIG. 16 to FIG. 20, the transistor cutoff is marked by “x”.

It should be noted that in the third stage T3, the fourth stage T4 and the fifth stage T5, the driving principle and the driving process of the circuit diagram shown in FIG. 7 are the same as the driving principle and the driving process of the circuit diagram shown in FIG. 1 above.

The driving process of the first stage T1 and the second stage T2 are only introduced and explained in detail below.

In the first stage (the resetting stage), such as the T1 stage shown in FIG. 8, the high level first scanning signal VG(n−4) is input to the first scanning signal line, and the low level third scanning signal VG(n) is input to the third scanning signal line, the low level fourth scanning signal VG(n−2) is input to the fourth scanning signal line, the low level fifth scanning signal VG(n+2) is input to the fifth scanning signal line and the low level light emitting controlling signal EM(n) is input to the light emitting controlling signal line.

At this moment, as shown in FIG. 16, the second transistor M2 and the fourth transistor M4 are turned on, the potential of the first node NS is the Vinit, and the potential of the second node NG is the Vref. Since both the Vref and the Vinit are high level potentials with constant voltages, the driving transistor MD is turned on. In this way, the resetting of the potential of the first node NS and the potential of the second node NG is completed. In addition, the electrodes (electrode plates) connected to the first capacitor C1 and the second capacitor C2 are pre-charged to prevent the extraction and compensation of the threshold voltage from being completed due to the capacitance to be charged is large in the subsequent threshold voltage extraction stage.

In the second stage (the threshold voltage extraction stage), such as the T2 stage shown in FIG. 8, the low level first scanning signal VG(n−4) is input to the first scanning signal line, the low level third scanning signal VG(n) is input to the third scanning signal line, the high level fourth scanning signal VG(n−2) is input to the fourth scanning signal line, and the low level fifth scanning signal VG(n+2) is input to the fifth scanning signal line, and the low level light emitting controlling signal EM(n) is input to the light emitting controlling signal line.

At this moment, as shown in FIG. 17, the eighth transistor M8 and the seventh transistor M7 are turned on, the first capacitor C1 can keep that the potential of the second node NG is still the Vref, the driving transistor MD remains the on-state, and a pathway is formed between the first power line VDD line and the first node NS. The first power line VDD line charges the first node NS. When the potential of the first node NS changes to be Vref−Vth, the driving transistor MD is turned off. Since the process changes slowly and the potential of the second node NG is always pulled by the Vref, the potential of the second node NG remains the Vref. At this moment, Vgs=Vref−(Vref−Vth)=Vth. Thus, the extraction of the threshold voltage Vth of the driving transistor MD is completed.

Taking the circuit diagram shown in FIG. 9 as an example, taking that the ninth transistor M9 is the P-type transistor and other transistors are the N-type transistors as an example, the driving principle and the driving process of the driving circuit are described in detail. FIG. 10 provides the timing sequence corresponding to the circuit diagram in FIG. 9.

It should be noted that in the first stage T1, the second stage T2, the fourth stage T4 and the fifth stage T5, the driving principle and the driving process of the circuit diagram shown in FIG. 4 are the same as the driving principle and the driving process of the circuit diagram shown in FIG. 1 above. The driving process of the third stage T3 is only introduced and explained in detail below.

In combination with FIG. 9 and FIG. 10, after the T2 stage and before the T3 stage, the high level sixth scanning signal VG(n−1) is input to the sixth scanning signal line, the tenth transistor M10 is turned on, and the ninth transistor M9 is turned off. Thus, the data signal Vdata transmitted by the data line Data line is written in advance into the position between the tenth transistor M10 and the ninth transistor M9.

In the T3 stage (data writing and compensation stage), the high level third scanning signal VG(n) is input to the third scanning signal line, the low level sixth scanning signal VG(n−1) is input to the sixth scanning signal line, the first transistor M1 and the ninth transistor M9 are turned on at the same time. The data signal Vdata can be quickly written into the gate electrode of the driving transistor MD through the ninth transistor M9, thus the transmission time of the data signal Vdata is shortened, the refresh speed and response speed of the pixel driving circuits are improved, and the display effect of the display apparatus is improved.

The above descriptions are only specific embodiments of the present application, however, the scope of protection of the present application is not limited thereto. A person skilled in the art can easily conceive of variations or substitutions within the technological scope revealed in the present application, which should be encompassed within the scope of protection of the present application. Therefore, the scope of protection of the present application should be determined by the scope of protection of the claims.

1. Pixel driving circuits, wherein the pixel driving circuit in an nth row comprises:
a first reset sub-circuit electrically connected to a first reset signal line, a first scanning signal line, a first node, a second reset signal line, a controlling signal line and a second node, and configured to reset a voltage of the first node under control of a first scanning signal and reset the second node under control of a first controlling signal;
a data writing sub-circuit electrically connected to a data line, a third scanning signal line and the second node, and configured to write a data signal transmitted by the data line into the second node;
a driving transistor, a gate electrode of the driving transistor being electrically connected to the second node, a first pole of the driving transistor being electrically connected to a third node, and a second pole of the driving transistor being electrically connected to the first node, and the driving transistor being configured to generate a driving current under control of a voltage of the second node;
a light emitting controlling sub-circuit electrically connected to a light emitting controlling signal line, a first power line, the third node, the first node and an anode of a light emitting device, and configured to, when the driving transistor is turned on, conduct a path between the first power line and a cathode of the light emitting device;
a compensating sub-circuit electrically connected to a fourth scanning signal line, the first power line and the third node, and configured to complete reading of a threshold voltage of the driving transistor in cooperation with the first reset sub-circuit;
a storing sub-circuit electrically connected to the first node, the second node and the first power line, and configured to store the voltage of the second node and adjust the voltage of the first node;
a second reset sub-circuit electrically connected to the anode, a fifth scanning signal line and a second power line, and configured to reset the anode under control of a fifth scanning signal;
wherein n is a positive integer, the first scanning signal line, the third scanning signal line, the fourth scanning signal line and the fifth scanning signal line are gate lines in different rows.

2. The pixel driving circuits according to claim 1, wherein the controlling signal line comprises the first scanning signal line or a second scanning signal line.

3. The pixel driving circuits according to claim 2, wherein a pulse width of a scanning signal loaded on the first scanning signal line, a pulse width of a scanning signal loaded on the third scanning signal line, a pulse width of a scanning signal loaded on the fourth scanning signal line and a pulse width of a scanning signal loaded on the fifth scanning signal line are same.

4. The pixel driving circuits according to claim 3, wherein the first scanning signal line is a gate line in an (n−4)th row, the third scanning signal line is a gate line in the nth row, the fourth scanning signal line is a gate line in an (n−2)th row, and the fifth scanning signal line is a gate line in an (n+2)th row; wherein n is greater than 4; and
the pixel driving circuit in an mth row is a dummy pixel driving circuit, m is a positive integer, m is greater than or equal to 1 and less than or equal to 4, equal to n+1 or n+2; and the pixel driving circuit in the mth row is electrically connected to a shift register in the mth row.

5. The pixel driving circuits according to claim 1, wherein the first reset signal line comprises a reference signal line, and the second reset signal line comprises an initialization signal line, an absolute value of a difference between a voltage of a reference signal transmitted by the reference signal line and a voltage of an initialization signal transmitted by the initialization signal line is greater than the threshold voltage of the driving transistor.

6. The pixel driving circuits according to claim 1, wherein the first reset signal line comprises the first power line, and the second reset signal line comprises the second power line.

7. The pixel driving circuits according to claim 4, wherein the data writing sub-circuit comprises a first transistor, a gate electrode of the first transistor is electrically connected to the third scanning signal line, a first pole of the first transistor is electrically connected to the data line, and a second pole of the first transistor is electrically connected to the second node.

8. The pixel driving circuits according to claim 4, wherein when the controlling signal line comprises the second scanning signal line, the data writing sub-circuit comprises a first transistor and a ninth transistor; and
a gate electrode of the first transistor is electrically connected to the third scanning signal line, a first pole of the first transistor is electrically connected to the data line, a second pole of the first transistor is electrically connected to a first pole of the ninth transistor, a gate electrode of the ninth transistor is electrically connected to the second scanning signal line, and a second pole of the ninth transistor is electrically connected to the second node.

9. The pixel driving circuits according to claim 8, wherein a third scanning signal and a second scanning signal overlap in time.

10. The pixel driving circuits according to claim 4, wherein when the controlling signal line comprises the second scanning signal line, the data writing sub-circuit comprises a first transistor, a ninth transistor, and a tenth transistor; and
a gate electrode of the first transistor is connected to the third scanning signal line, a first pole of the first transistor is electrically connected to the data line, a second pole of the first transistor is electrically connected to a first pole of the ninth transistor; a gate electrode of the ninth transistor is electrically connected to the second scanning signal line, a second pole of the ninth transistor is electrically connected to the second node; a first pole of the tenth transistor is electrically connected to the data line, a second pole of the tenth transistor is electrically connected to the first pole of the ninth transistor, and a gate electrode of the tenth transistor is electrically connected to a sixth scanning signal line.

11. The pixel driving circuits according to claim 10, wherein a sixth scanning signal and a second scanning signal overlap in time.

12. The pixel driving circuits according to claim 4, wherein when the controlling signal line comprises the first scanning signal line, the data writing sub-circuit comprises a first transistor, a ninth transistor, and a tenth transistor; and
a gate electrode of the first transistor is electrically connected to the third scanning signal line, a first pole of the first transistor is electrically connected to the data line, a second pole of the first transistor is electrically connected to a first pole of the ninth transistor, a gate electrode of the ninth transistor is electrically connected to a sixth scanning signal line, a second pole of the ninth transistor is electrically connected to the second node, a gate electrode of the tenth transistor is electrically connected to the sixth scanning signal line, a first pole of the tenth transistor is electrically connected to the data line, and a second pole of the tenth transistor is electrically connected to the first pole of the ninth transistor.

13. The pixel driving circuits according to claim 11, wherein the sixth scanning signal line is a gate line in an (n−1)th row, and a pulse width of a scanning signal loaded on the sixth scanning signal line is the same as a pulse width of a scanning signal loaded on the first scanning signal line.

14. The pixel driving circuits according to claim 7, wherein when the controlling signal line comprises the second scanning signal line, the first reset sub-circuit comprises a second transistor and a fourth transistor; and
a gate electrode of the second transistor is electrically connected to the second scanning signal line, a first pole of the second transistor is electrically connected to the second reset signal line, a second pole of the second transistor is electrically connected to the second node, a gate electrode of the fourth transistor is electrically connected to the first scanning signal line, a first pole of the fourth transistor is electrically connected to the first reset signal line, and a second pole of the fourth transistor is electrically connected to the first node.

15. The pixel driving circuits according to claim 7, wherein when the controlling signal line comprises the first scanning signal line, the first reset sub-circuit comprises a second transistor, a fourth transistor and an eighth transistor; and
a gate electrode of the second transistor and a gate electrode of the fourth transistor are both electrically connected to the first scanning signal line, a first pole of the second transistor is electrically connected to the second reset signal line, a second pole of the second transistor is electrically connected to the second node; a first pole of the fourth transistor is electrically connected to the first reset signal line, and a second pole of the fourth transistor is electrically connected to the first node; a gate electrode of the eighth transistor is electrically connected to the fourth scanning signal line, a first pole of the eighth transistor is electrically connected to the second reset signal line, and a second pole of the eighth transistor is electrically connected to the second node.

16. The pixel driving circuits according to claim 4, wherein the light emitting controlling sub-circuit comprises a third transistor and a fifth transistor; and
a gate electrode of the third transistor and a gate electrode of the fifth transistor are both electrically connected to the light emitting controlling signal line; a first pole of the third transistor is electrically connected to the first power line, and a second pole of the third transistor is electrically connected to the third node; a first pole of the fifth transistor is electrically connected to the first node, and a second pole of the fifth transistor is electrically connected to the anode.

17. The pixel driving circuits according to claim 16, wherein the compensating sub-circuit comprises a seventh transistor, a gate electrode of the seventh transistor is electrically connected to the fourth scanning signal line, a first pole of the seventh transistor is electrically connected to the first power line, and a second pole of the seventh transistor is electrically connected to the third node.

18. The pixel driving circuits according to claim 17, wherein the storing sub-circuit comprises a first capacitor and a second capacitor; and
a first electrode of the first capacitor is electrically connected to the second node, a second electrode of the first capacitor is electrically connected to the first node; a first electrode of the second capacitor is electrically connected to the first power line, and a second electrode of the second capacitor is electrically connected to the second electrode of the first capacitor through the first node.

19-26. (canceled)

27. A display apparatus, wherein the display apparatus comprises the pixel driving circuits according to claim 1.

28. A driving method, applied to drive the pixel driving circuits according to claim 1, wherein the driving method comprises:
in a first stage, inputting a low level light emitting controlling signal to the light emitting controlling signal line, inputting a high level first scanning signal to the first scanning signal line, inputting a low level fourth scanning signal to the fourth scanning signal line, inputting a low level third scanning signal to the third scanning signal line, and inputting a low level fifth scanning signal to the fifth scanning signal line;
in a second stage, inputting the low level light emitting controlling signal to the light emitting controlling signal line, inputting a low level first scanning signal to the first scanning signal line, inputting a high level fourth scanning signal to the fourth scanning signal line, inputting the low level third scanning signal to the third scanning signal line, and inputting the low level fifth scanning signal to the fifth scanning signal line;
in a third stage, inputting the low level light emitting controlling signal to the light emitting controlling signal line, inputting the low level first scanning signal to the first scanning signal line, inputting the low level fourth scanning signal to the fourth scanning signal line, inputting a high level third scanning signal to the third scanning signal line, and inputting the low level fifth scanning signal to the fifth scanning signal line;
in a fourth stage, inputting the low level light emitting controlling signal to the light emitting controlling signal line, inputting the low level first scanning signal to the first scanning signal line, inputting the low level fourth scanning signal to the fourth scanning signal line, inputting the low level third scanning signal to the third scanning signal line, and inputting a high level fifth scanning signal to the fifth scanning signal line; and
in a fifth stage, inputting a high level light emitting controlling signal to the light emitting controlling signal line, inputting the low level first scanning signal to the first scanning signal line, inputting the low level fourth scanning signal to the fourth scanning signal line, inputting the low level third scanning signal to the third scanning signal line, and inputting the low level fifth scanning signal to the fifth scanning signal line.
